(19) United States
(12) Patent Application Publication
(10) Pub. No.: US 2026/0350297 A1
(43) Pub. Date: Nov. 5, 2026

(54) Systems and Methods for Collaborative Annotation and Sharing of Media Content Based on Access Controlled Layering of Multiple Data Objects

(71) Applicant: Renyooit LLC, Pleasanton, CA (US)

(72) Inventors: Lakshmi Nagarajan, San Ramon, CA (US); Raja Nagarajan, San Ramon, CA (US); Raghushri Sankaran, West Windsor, NJ (US)

(21) Appl. No.: 19/485,846

(22) PCT Filed: May 14, 2024
(86) PCT No.: PCT/US2024/029204

§ 371 Date: Nov. 19, 2025

Related U.S. Application Data
(60) Provisional application No. 63/503,293, filed on May 19, 2023.

(51) Int. Cl. G06F 40/169; G06F 3/0482

(52) U.S. Cl. CPC G06F 40/169; G06F 3/0482

(57) ABSTRACT

An example method for collaborative media content annotation and sharing is provided. The method includes displaying, by a computing device, an image. The method includes receiving, by the computing device and from a user, a user indication that a portion of the image is to be annotated. The method includes, responsive to the user indication, displaying a selectable virtual graphical object on the image, wherein the selectable virtual graphical object indicates an annotation of the portion of the image. The method includes providing, by the computing device, one or more user selectable options to upload media content associated with the annotated portion of the image. The method includes providing, by the computing device, an annotated image, wherein the annotated image comprises the selectable virtual graphical object.

### CROSS-REFERENCE TO RELATED APPLICATIONS

This present application claims priority to a U.S. provisional application Ser. No. 63/503,293 filed May 19, 2023, the full disclosure of which is incorporated herein by reference.

### BACKGROUND

Media content, such as images, video, audio, and so forth, is a popular medium for sharing and/or transmitting information. Media content is shared across multiple applications, including social media platforms, enterprise application service platforms, electronic commerce websites, news publications, educational resources, computer games, and so forth, just to name a few. Also, for example, media content is used in do-it-yourself (DIY) projects, engineering design, apparel design, instruction manuals for various products, product repair documents, and so forth. In some instances, media content sharing platforms enable users to share media content with each other. The sharing platform can be configured to receive and store media content that is uploaded by the users, and share such content across multiple users and/or devices.

### SUMMARY

If an image is worth a thousand words, as a popular adage goes, then an annotated image is likely to be worth many more. Indeed, many product manuals (e.g., instruction manuals, owners' manuals, repair manuals) are documents with multiple pages, and/or include highly technical diagrams, descriptions, and so forth. For example, the product manual may not illustrate a particular technical specification. Also, for example, the product manual may provide a generic, schematic illustration of a feature, and a user may not understand whether, or how, the description may apply to their particular product. Similarly, product design documents can be somewhat confusing when a user applying the design in a manufacturing of the product, or in constructing the building, is not able to quickly view design features of various parts of the product and/or building. Even when the information is available, such information may be buried in a user manual, and may require considerable time and effort on the part of the user to find the information, map it to their own product, understand the content, and then use the information. Accordingly, there is a technical problem of a lack of relevant information and/or availability of information in an easily accessible and user friendly manner. Therefore, there is a need for a technical solution to this technical problem, as described herein. In particular, as an example, an annotated image may be provided with selectable “hotspots” that highlight various aspects of the image. The term “image” as used herein, may generally refer to a two-dimensional (2D) image, a three-dimensional (3D) image, a video (e.g., frames of a video), a hologram, an image in a virtual reality (VR) space or an augmented reality (AR) space, etc. Each such “hotspot” may be associated with multiple media content (e.g., images, text, video, audio, web resource link, and so forth) that can provide additional information. In some embodiments, a hierarchical data structure may be generated with multiple layers of linked hotspots. For example, a first annotated media content may include one or more hotspots, each hotspot being linked to additional media content that may or may not include further respective annotations and/or hotspots. As a result, a given media content may then be associated with a hierarchical data structure, where each layer of the hierarchical structure provides additional informational content for the given media content. In some instances, such annotated images may also be generated by a user. Thus, user manuals, design documents, etc. can be transformed into interactive documents where multiple users may add further content to enhance the user manuals, design documents, etc.

Social media platforms are a popular way of sharing media content among users. For example, users can share images, videos, documents, and so forth with each other. Oftentimes, users may want to highlight specific portions of a media content. For example, a user may want to highlight a specific portion of an image and enhance the image with additional context. For example, a user visiting Paris may capture an image that includes the Eiffel Tower. The user may then want to display a selfie that the user captured at the top of the Eiffel Tower. Accordingly, there is a need to enable an addition of one or more “hotspots” to a media content. In this example, the user may add a hotspot to the portion of the image corresponding to the top of the Eiffel Tower, and associate their selfie with the hotspot. For example, the user can select the hotspot and upload the selfie, thereby linking the selfie to the hotspot. Another user viewing the image can view the hotspot, select it, and view the selfie. The second user may add a piece of music to the same hotspot, or add a new hotspot and link the piece of music to the new hotspot.

Accordingly, there is a need for a content sharing solution that not only enables sharing of information as media content, but additionally enables the users to enhance the shared information by annotating the media content with hotspots, and linking the hotspots with additional media content, each of which may include additional hotspots. As a result, a collaborative media content annotation and sharing experience may be created based on access controlled layering of multiple data objects.

Some existing approaches to annotation and/or sharing of media content enable a user to annotate an image and share it via various platforms including e-commerce platforms, content, and/or media sharing platforms. However, such approaches do not enable additional users to add annotations to the shared image. Also, for example, such approaches do not enable an annotated image to include a hotspot that links to additional media content. Generally speaking, existing approaches do not provide various aspects of a hierarchical data structure of hotspots for annotating and/or sharing media content as described herein.

In one aspect, a computer-implemented method for collaborative media content annotation and sharing is provided. The method includes displaying, by a computing device, an image. The method includes receiving, by the computing device and from a user, a user indication that a portion of the image is to be annotated. The method includes, responsive to the user indication, displaying a selectable virtual graphical object on the image, wherein the selectable virtual graphical object indicates an annotation of the portion of the image. The method includes providing, by the computing device, one or more user selectable options to upload media content associated with the annotated portion of the image. The method includes providing, by the computing device, an annotated image, wherein the annotated image comprises the selectable virtual graphical object.

In a second aspect, a computing device for collaborative media content annotation and sharing is provided. The computing device includes one or more processors and data storage. The data storage has stored thereon computer-executable instructions that, when executed by one or more processors, cause the computing device to carry out functions. The functions include: displaying, by a computing device, an image; receiving, by the computing device and from a user, a user indication that a portion of the image is to be annotated; responsive to the user indication, displaying a selectable virtual graphical object on the image, wherein the selectable virtual graphical object indicates an annotation of the portion of the image; providing, by the computing device, one or more user selectable options to upload media content associated with the annotated portion of the image; and providing, by the computing device, an annotated image, wherein the annotated image comprises the selectable virtual graphical object.

In a third aspect, a computer program for collaborative media content annotation and sharing is provided. The computer program includes instructions that, when executed by a computer, cause the computer to carry out functions. The functions include: displaying, by a computing device, an image; receiving, by the computing device and from a user, a user indication that a portion of the image is to be annotated; responsive to the user indication, displaying a selectable virtual graphical object on the image, wherein the selectable virtual graphical object indicates an annotation of the portion of the image; providing, by the computing device, one or more user selectable options to upload media content associated with the annotated portion of the image; and providing, by the computing device, an annotated image, wherein the annotated image comprises the selectable virtual graphical object.

In a fourth aspect, an article of manufacture for collaborative media content annotation and sharing is provided. The article of manufacture includes one or more computer readable media having computer-readable instructions stored thereon that, when executed by one or more processors of a computing device, cause the computing device to carry out functions. The functions include: displaying, by a computing device, an image; receiving, by the computing device and from a user, a user indication that a portion of the image is to be annotated; responsive to the user indication, displaying a selectable virtual graphical object on the image, wherein the selectable virtual graphical object indicates an annotation of the portion of the image; providing, by the computing device, one or more user selectable options to upload media content associated with the annotated portion of the image; and providing, by the computing device, an annotated image, wherein the annotated image comprises the selectable virtual graphical object.

In a fifth aspect, a system for collaborative media content annotation and sharing is provided. The system includes means for displaying, by a computing device, an image; means for receiving, by the computing device and from a user, a user indication that a portion of the image is to be annotated; means for, responsive to the user indication, displaying a selectable virtual graphical object on the image, wherein the selectable virtual graphical object indicates an annotation of the portion of the image; means for providing, by the computing device, one or more user selectable options to upload media content associated with the annotated portion of the image; and means for providing, by the computing device, an annotated image, wherein the annotated image comprises the selectable virtual graphical object.

In a sixth aspect, a system for collaborative media content annotation and sharing is provided. The system includes a first computing device, and a second computing device. The system also includes one or more processors, and data storage. The data storage has stored thereon computer-executable instructions that, when executed by the one or more processors, cause the one or more processors to carry out functions. The functions include: receiving, from the first computing device, a user indication that a portion of an image is to be annotated; responsive to the receiving of the user indication, causing the first computing device to display a selectable virtual graphical object on the image, wherein the selectable virtual graphical object indicates an annotation of the portion of the image; causing the first computing device to display one or more user selectable options to upload media content associated with the annotated portion of the image; and providing, to the first computing device and the second computing device, an annotated image, wherein the annotated image comprises the selectable virtual graphical object.

In a seventh aspect, a computer-implemented method for displaying annotated images is provided. The method includes displaying, by a computing device, an annotated image, wherein the annotated image comprises one or more selectable virtual graphical objects located at respective portions of the annotated image. The method includes detecting a selection of a particular selectable virtual graphical object associated with a particular portion of the annotated image. The method includes, responsive to the detecting of the selection of the particular selectable virtual graphical object, providing, by the computing device, a plurality of selectable tabs associated with the particular selectable virtual graphical object, wherein each tab of the plurality of selectable tabs is linked to a media content associated with the particular portion.

In an eighth aspect, a computing device for displaying annotated images is provided. The computing device includes one or more processors and data storage. The data storage has stored thereon computer-executable instructions that, when executed by one or more processors, cause the computing device to carry out functions. The functions include: displaying, by a computing device, an annotated image, wherein the annotated image comprises one or more selectable virtual graphical objects located at respective portions of the annotated image; detecting a selection of a particular selectable virtual graphical object associated with a particular portion of the annotated image; responsive to the detecting of the selection of the particular selectable virtual graphical object, providing, by the computing device, a plurality of selectable tabs associated with the particular selectable virtual graphical object, wherein each tab of the plurality of selectable tabs is linked to a media content associated with the particular portion.

In a ninth aspect, a computer program for displaying annotated images is provided. The computer program includes instructions that, when executed by a computer, cause the computer to carry out functions. The functions include: displaying, by a computing device, an annotated image, wherein the annotated image comprises one or more selectable virtual graphical objects located at respective portions of the annotated image; detecting a selection of a particular selectable virtual graphical object associated with a particular portion of the annotated image; responsive to the detecting of the selection of the particular selectable virtual graphical object, providing, by the computing device, a plurality of selectable tabs associated with the particular selectable virtual graphical object, wherein each tab of the plurality of selectable tabs is linked to a media content associated with the particular portion.

In a tenth aspect, an article of manufacture for displaying annotated images is provided. The article of manufacture includes one or more computer readable media having computer-readable instructions stored thereon that, when executed by one or more processors of a computing device, cause the computing device to carry out functions. The functions include: displaying, by a computing device, an annotated image, wherein the annotated image comprises one or more selectable virtual graphical objects located at respective portions of the annotated image; detecting a selection of a particular selectable virtual graphical object associated with a particular portion of the annotated image; responsive to the detecting of the selection of the particular selectable virtual graphical object, providing, by the computing device, a plurality of selectable tabs associated with the particular selectable virtual graphical object, wherein each tab of the plurality of selectable tabs is linked to a media content associated with the particular portion.

In an eleventh aspect, a system for displaying annotated images is provided. The system includes means for displaying, by a computing device, an annotated image, wherein the annotated image comprises one or more selectable virtual graphical objects located at respective portions of the annotated image; means for detecting a selection of a particular selectable virtual graphical object associated with a particular portion of the annotated image; means for providing, by the computing device, one or more user selectable options to upload media content associated with the annotated portion of the image; and means for, responsive to the detecting of the selection of the particular selectable virtual graphical object, providing, by the computing device, a plurality of selectable tabs associated with the particular selectable virtual graphical object, wherein each tab of the plurality of selectable tabs is linked to a media content associated with the particular portion.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1A illustrates an example interactive graphical user interface in a first state, in accordance with example embodiments.

FIG. 1B illustrates an example interactive graphical user interface in a second state, in accordance with example embodiments.

FIG. 1C illustrates an example interactive graphical user interface in a third state, in accordance with example embodiments.

FIG. 1D illustrates an example interactive graphical user interface in a fourth state, in accordance with example embodiments.

FIG. 1E illustrates an example interactive graphical user interface in a fifth state, in accordance with example embodiments.

FIG. 1F illustrates an example interactive graphical user interface in a sixth state, in accordance with example embodiments.

FIG. 1G illustrates an example interactive graphical user interface in a seventh state, in accordance with example embodiments.

FIG. 1H illustrates an example interactive graphical user interface in an eighth state, in accordance with example embodiments.

FIG. 1I illustrates an example interactive graphical user interface in a ninth state, in accordance with example embodiments.

FIG. 1J illustrates an example interactive graphical user interface in a tenth state, in accordance with example embodiments.

FIG. 2 illustrates a media content sharing environment, in accordance with example embodiments.

FIG. 3A illustrates an example interactive graphical user interface for design specifications in a first state, in accordance with example embodiments.

FIG. 3B illustrates an example interactive graphical user interface for design specifications in a second state, in accordance with example embodiments.

FIG. 3C illustrates an example interactive graphical user interface for design specifications in a third state, in accordance with example embodiments.

FIG. 4A illustrates an example interactive graphical user interface for an automotive instruction manual in a first state, in accordance with example embodiments.

FIG. 4B illustrates an example interactive graphical user interface for an automotive instruction manual in a second state, in accordance with example embodiments.

FIG. 4C illustrates an example interactive graphical user interface for an automotive instruction manual in a third state, in accordance with example embodiments.

FIG. 4D illustrates an example interactive graphical user interface for an automotive instruction manual in a fourth state, in accordance with example embodiments.

FIG. 5 illustrates an example interactive graphical user interface for an automotive repair manual, in accordance with example embodiments.

FIG. 6 illustrates an example interactive graphical user interface associated with displaying a three-dimensional (3D) image, in accordance with example embodiments.

FIG. 7 illustrates an example interactive graphical user interface associated with displaying an annotated video, in accordance with example embodiments.

FIG. 8 depicts a distributed computing environment, in accordance with example embodiments.

FIG. 9 is a block diagram of a computing device, in accordance with example embodiments.

FIG. 10 is a flowchart of a method for collaborative media content annotation and sharing, in accordance with example embodiments.

FIG. 11 is a flowchart of a method for displaying annotated images, in accordance with example embodiments.

### DETAILED DESCRIPTION

This application relates, in one aspect, to a collaborative media content annotation and sharing platform based on access controlled layering of multiple data objects.

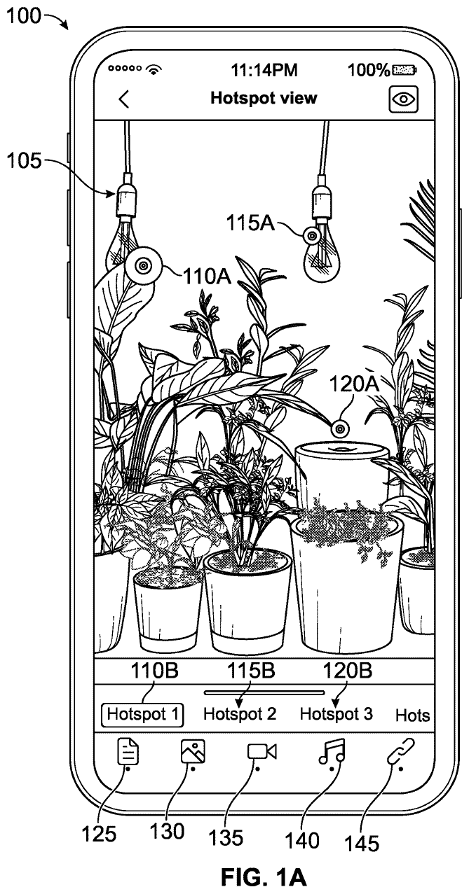

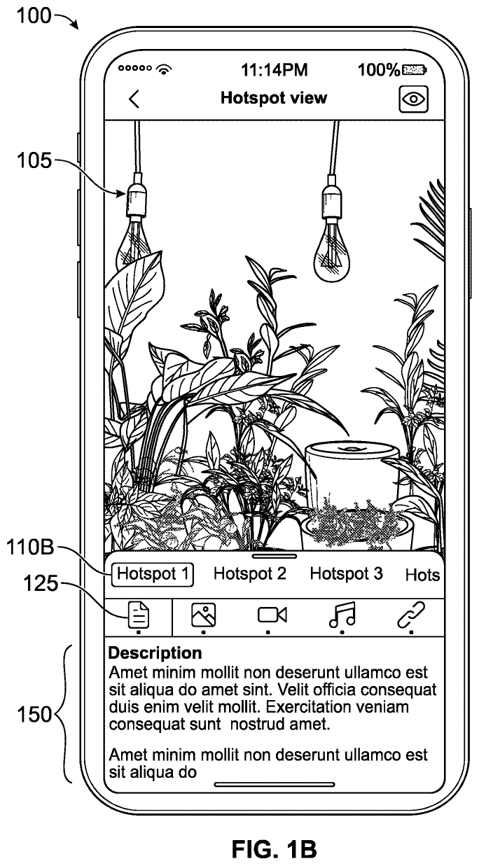

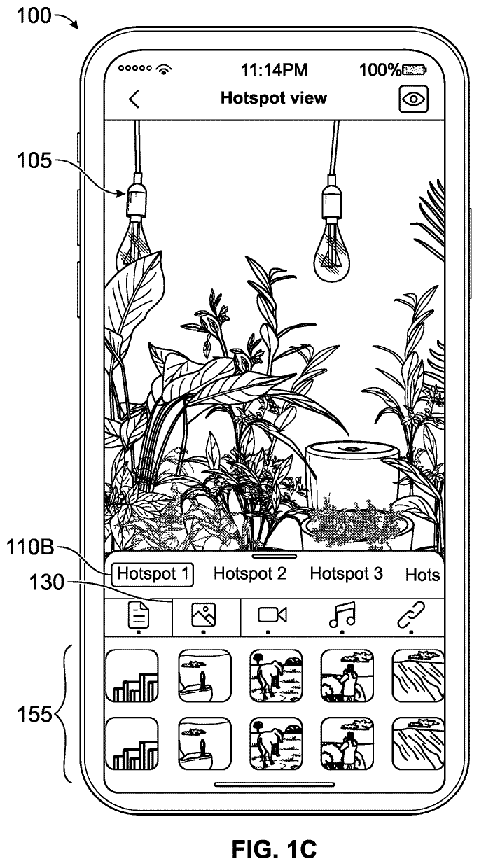

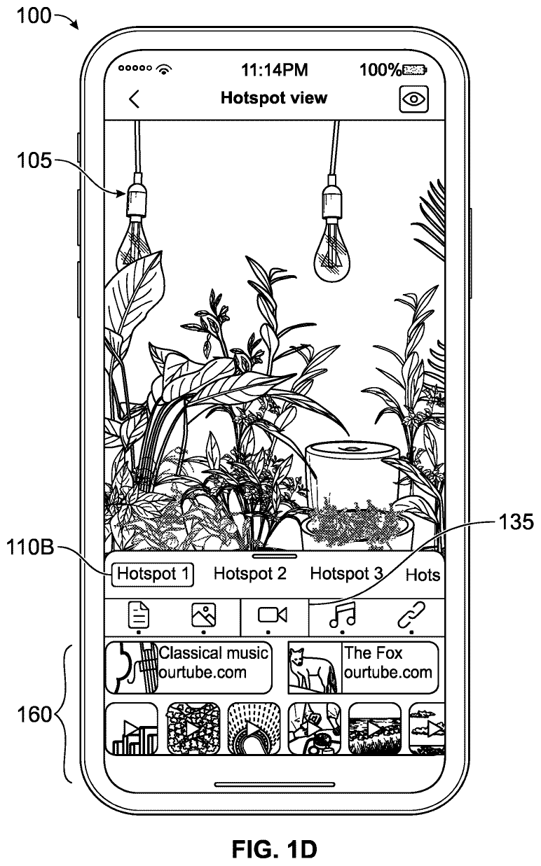

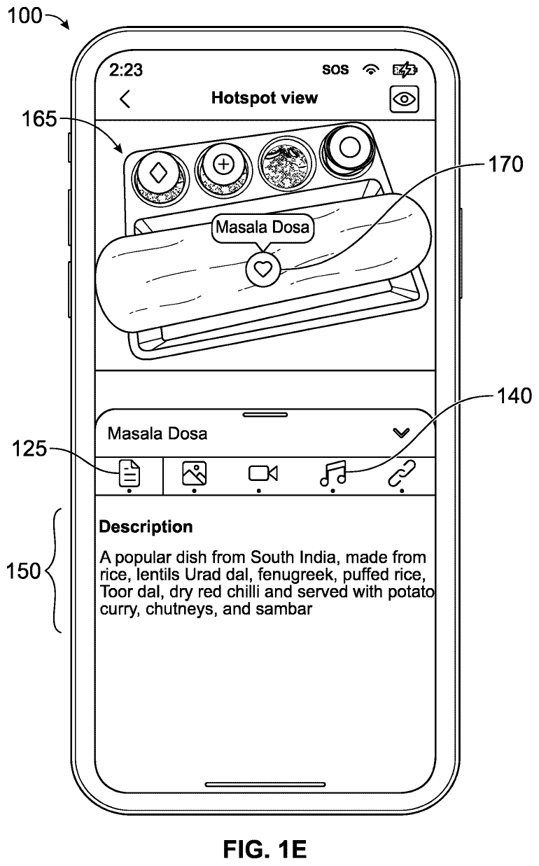

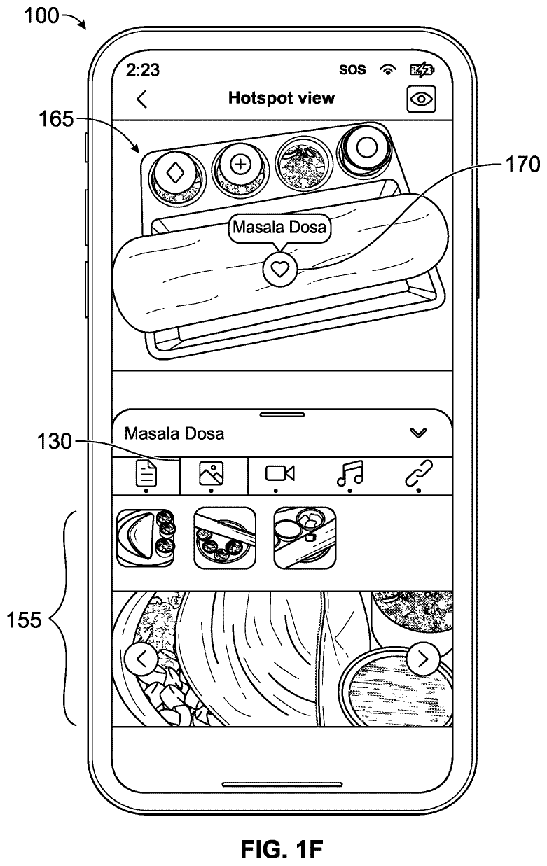

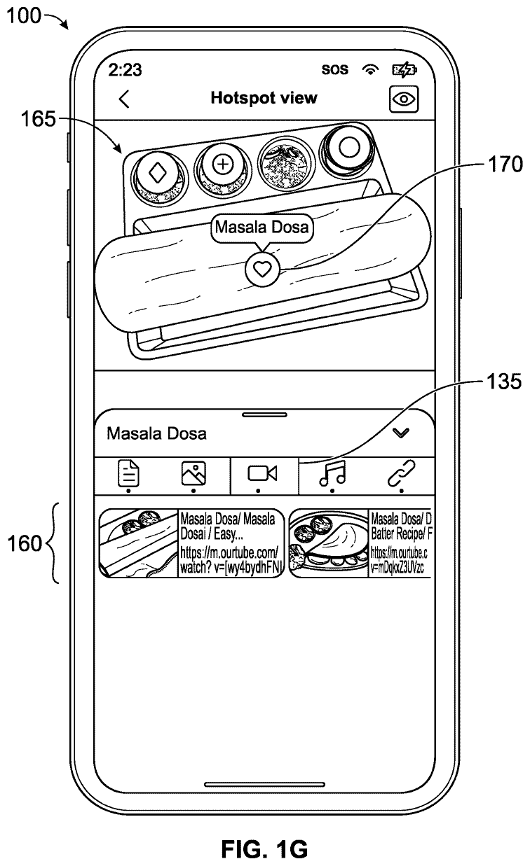

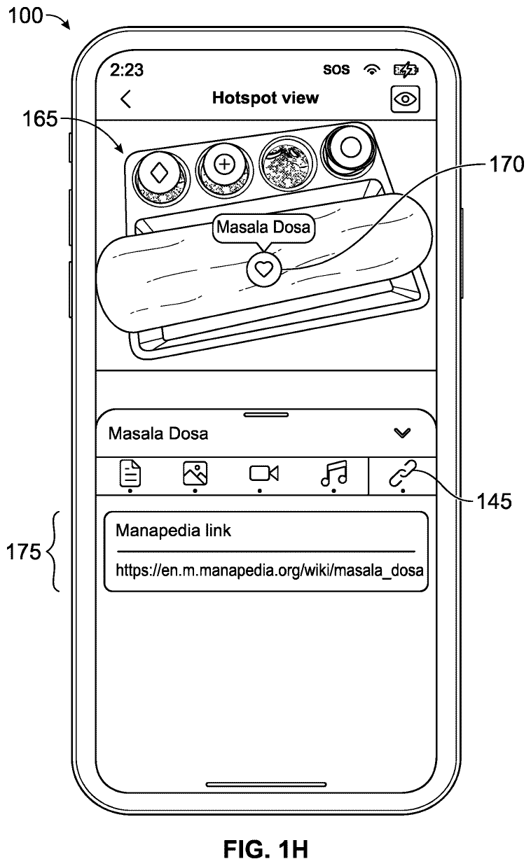

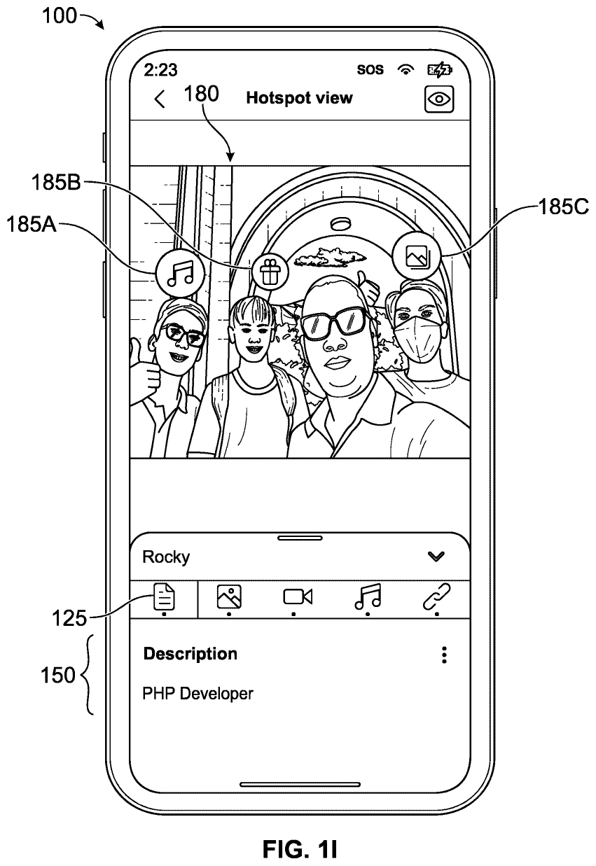

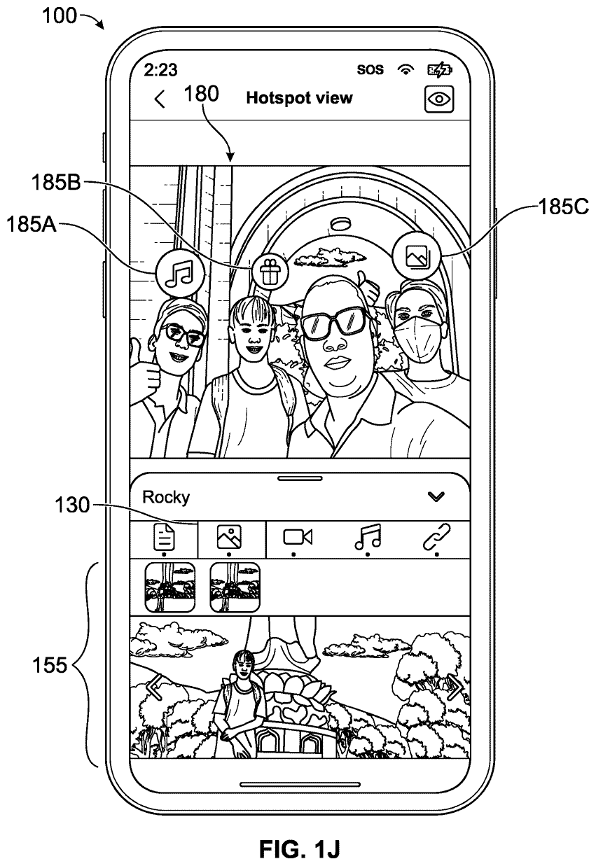

FIG. 1A illustrates an example interactive graphical user interface in a first state, in accordance with example embodiments. Computing device 100 can include an interactive graphical user interface (GUI) that displays image 105. In some aspects, image 105 may be captured by an image capturing device of computing device 100. Also, for example, image 105 can be an image stored in computing device 100. As another example, image 105 can be shared by another user, for example, over a shared media platform such as one described herein. A user of computing device 100 may wish to annotate a portion of image 105. For example, the user may click on image 105 and a hotspot 110A may be displayed to indicate a position on image 105 where the user intends to add an annotation. In some examples, hotspot 110A may be shared simultaneously across all devices that have access to shared copies of image 105. For example, a media sharing platform (e.g., a server) may be configured to receive indication from computing device 100 that the hotspot 110A has been created, and share the annotated image across all shared devices associated with the media sharing platform. This way, the annotated image becomes available to multiple users simultaneously. In some embodiments, when hotspot 110A is added, a selectable tab 110B labeled “Hotspot 1”, may be added to the displayed annotated image. The term “media sharing platform” as used herein, generally refers to any platform that enables users to share media, and can include, for example, ecommerce platforms, content sharing platforms, social networking platforms, and so forth. The media sharing may occur over a website browser, application programs, etc.

In some embodiments, the same user (or one or more additional users) may add additional hotspots, as indicated by hotspot 115A and associated selectable tab 115B labeled “Hotspot 2,” and hotspot 120A and associated selectable tab 120B labeled “Hotspot 3.”

The term “hotspot” as used herein, generally refers to a virtual graphical object displayed on media content to mark a location of an annotation. Generally speaking, a hotspot may be selectable (e.g., it can be selected by clicking, hovering over, or by a speech input instructing a virtual assistant to make a selection). Although the examples herein relate to annotating an image, this is for illustrative purposes only. Generally, textual documents may be annotated, a portion of video or audio content may be annotated, and so forth. In general, any media content may be annotated with a hotspot. For example, when displaying a video, a portion below the video display may include a horizontal bar indicating progress of the video. Such a horizontal bar may include hotspots or indicators at various locations, indicating to a viewer that annotated content is available at those particular locations of the video. Similar considerations may apply to audio content. In some embodiments, aspects of such annotations may be provided in conjunction with existing media playing devices, and/or media streaming application programs. Also, although hotspots 110A, 115A, and 120A are shown to be circular in shape, the virtual graphical object may be of any shape.

Another embodiment within the scope of this description is a situation where the interactive GUI is in a virtual reality (VR) and/or augmented reality (AR) environment. In such situations, the hotspots may be created in a three-dimensional (3D) environment, and can be associated with 3D coordinates with respect to a relevant frame of reference. The 3D environment can be a shared environment, and various users may interact with the environment to add hotspots and annotate the 3D environment.

Also shown in FIG. 1A are selectable options for uploading various types of media content. For example, when a user generates one or more of hotspots 110A, 115A, and/or 120A, the user may have an option to associate one or more media content files with the one or more of hotspots 110A, 115A, and/or 120A. For example, the user may select first icon 125 to upload a textual document that includes a description related to the one or more of hotspots 110A, 115A, and/or 120A. Also, for example, the user may select second icon 130 to upload another image and associate the other image with the one or more of hotspots 110A, 115A, and/or 120A. As another example, the user may select third icon 135 to upload video content and associate the video content with the one or more of hotspots 110A, 115A, and/or 120A. Also, for example, the user may select fourth icon 140 to upload audio content and associate the audio content with the one or more of hotspots 110A, 115A, and/or 120A. As another example, the user may select fifth icon 145 to upload other attachments and associate the other attachments with the one or more of hotspots 110A, 115A, and/or 120A.

In some embodiments, selecting icon 130 may activate an image capturing device of computing device 100, and the user may capture an image to be uploaded and associated with the one or more of hotspots 110A, 115A, and/or 120A. In some embodiments, selecting icon 130 may activate a photo app or photo library to be accessed and the user may select a stored image. Similarly, selecting icon 135 may activate a video camera of computing device 100, and the user may capture a video to be uploaded and associated with the one or more of hotspots 110A, 115A, and/or 120A. In some embodiments, selecting icon 135 may activate a video app, streaming media app, or a video library to be accessed and the user may select a stored video. Likewise, selecting icon 140 may activate a microphone or a music app of computing device 100, and the user may capture audio content, select music from a music library, etc. to be uploaded and associated with the one or more of hotspots 110A, 115A, and/or 120A. Other examples of media upload capabilities are possible.

In other embodiments, the user may select the selectable tab 110B for “Hotspot 1.” Accordingly, the computing device 100 may display all media content linked to hotspot 110A that are available for viewing. Note that various users may have various content access restrictions that may restrict access to one or more media content. For example, a first user may be able to access all the media content associated with hotspot 110A. On the other hand, a second user may only access images associated with hotspot 110A. Also, for example, of the available images linked to hotspot 110A, the second user may be able to access a first collection of these available images, while a third user may be able to access a second collection of these available images. Adding such access controls allows all users to freely view a shared image, where each user is able to view only certain aspects of the media content linked (tagged, or associated) with the media content. This allows for heightened privacy restrictions that are a hallmark of this disclosure.

Generally speaking, each image may be considered to be layered with various hotspots, and each hotspot is associated with various media content. Accordingly, the image itself is transformed into a multi-layered data structure. For example, a first image may include multiple hotspots, where each hotspot links to additional media content. Each such media content may then include respective hotspots, linking to further media content. Accordingly, one example hierarchical data structure may include a tree-like structure with the first image as a node, and with edges to additional nodes that correspond to the additional media content. Another example of a hierarchical data structure may include a tree-like structure where the nodes are the hotspots, and the edges are the links from one hotspot to the next. For example, a first image may have two hotspots A and B. Hotspot A may link to media content I which includes three hotspots IA, IB, and IC. Accordingly, A is linked with edges to IA, IB, and IC.

Access restrictions can be associated with various aspects of this data structure, and these may be practically reflected in what is observable to a particular user. Access restrictions may also include, for example, encrypted media content. For example, different users and/or computing devices may have different decryption capabilities. As a result, one user may be able to decrypt a particular media content, while another user may not be able to decrypt the same media content. Access restrictions may relate to age (e.g., some media content may not be available for certain age groups), geographical location (e.g., some copyrighted media may not be available in certain jurisdictions), user based preferences (e.g., some users may filter content based on a type of content, a source of the content etc.). Other examples of restriction based access are possible. For example, each node in the tree-like structures described above may be associated with multiple access restrictions. Accordingly, a subtree of the entire tree may be accessible to a particular user based on their access privileges.

Referring again to FIG. 1A, the user may select the selectable tab 110B for “Hotspot 1.” Accordingly, as previously noted, the computing device 100 may display media content linked to hotspot 110A that are available for viewing for the particular user (e.g., based on the relevant access restrictions and/or filters). In some embodiments, selectable icons 125, 130, 135, 140, and/or 145 may be used to view a type of uploaded media content. As such, these icons may perform a dual role. When a hotspot 110A is created by a user, these selectable icons 125, 130, 135, 140, and/or 145 may function as upload buttons. However, when a user selects an existing hotspot 110A, the selectable icons 125, 130, 135, 140, and/or 145 can function as tabs to view the previously uploaded media content. For an existing hotspot, a user may be provided with an opportunity to add additional media content, and then these selectable icons 125, 130, 135, 140, and/or 145 again function as upload buttons.

FIG. 1B illustrates an example interactive graphical user interface in a second state, in accordance with example embodiments. FIG. 1B shares one or more aspects in common with FIG. 1A. In this example, the selectable tab 110B for “Hotspot 1” may be selected. This indicates that the user is able to add media content that will be linked to “Hotspot 1” (e.g., hotspot 110A of FIG. 1A), and/or view previously uploaded media content associated with “Hotspot 1.” In this example, the user may select icon 125. Accordingly, textual description 150 may be either available for upload, or in another embodiment, the computing device 100 may display textual description 150 (e.g., as a previously uploaded media content).

FIG. 1C illustrates an example interactive graphical user interface in a third state, in accordance with example embodiments. FIG. 1C shares one or more aspects in common with FIGS. 1A-1B. In this example, the selectable tab 110B for “Hotspot 1” may be selected. This indicates that the user is able to add media content that will be linked to “Hotspot 1” (e.g., hotspot 110A of FIG. 1A), and/or view previously uploaded media content associated with “Hotspot 1.” In this example, the user may select icon 130. Accordingly, images 155 may be either available for upload, or in another embodiment, the computing device 100 may display images 155 (e.g., as a previously uploaded media content).

FIG. 1D illustrates an example interactive graphical user interface in a fourth state, in accordance with example embodiments. FIG. 1D shares one or more aspects in common with FIGS. 1A-1C. In this example, the selectable tab 110B for “Hotspot 1” may be selected. This indicates that the user is able to add media content that will be linked to “Hotspot 1” (e.g., hotspot 110A of FIG. 1A), and/or view previously uploaded media content associated with “Hotspot 1.” In this example, the user may select icon 135. Accordingly, video content 160 may be either available for upload, or in another embodiment, the computing device 100 may display video content 160 (e.g., as a previously uploaded media content). In some examples, the video content may be separated via genre, or any other relevant classification.

FIG. 1E illustrates an example interactive graphical user interface in a fifth state, in accordance with example embodiments. Image 165 of a particular culinary dish is shown. FIG. 1E shares one or more aspects in common with FIGS. 1A-1D. In this example, the selectable tab, hotspot 170 for “Masala Dosa” may be created and/or an existing hotspot may be selected. This indicates that the user is able to add media content that will be linked to the selectable tab 170, and/or view previously uploaded media content associated with the selectable tab 170. In this example, the user may select icon 125. Accordingly, textual description 150 may be either available for upload, or in another embodiment, the computing device 100 may display textual description 150 (e.g., as a previously uploaded media content). Also, for example, a visual indication 125 of a filled in circle below icon 125 may indicate that textual documents are available for viewing. Also, a lack of a dot (such as below icon 140) may indicate that audio content is not available for viewing. This may be due to a lack of any uploaded audio content associated with hotspot 170, and/or because access restrictions make such content unavailable.

FIG. 1F illustrates an example interactive graphical user interface in a sixth state, in accordance with example embodiments. FIG. 1F shares one or more aspects in common with FIGS. 1A-1E. In this example, the selectable tab, hotspot 170 for “Masala Dosa” may be created and/or an existing hotspot may be selected. This indicates that the user is able to add media content that will be linked to the selectable tab 170, and/or view previously uploaded media content associated with the selectable tab 170. In this example, the user may select icon 130. Accordingly, images 155 may be either available for upload, or in another embodiment, the computing device 100 may display images 155 (e.g., as a previously uploaded media content).

FIG. 1G illustrates an example interactive graphical user interface in a seventh state, in accordance with example embodiments. FIG. 1G shares one or more aspects in common with FIGS. 1A-1F. In this example, the selectable tab, hotspot 170 for “Masala Dosa” may be created and/or an existing hotspot may be selected. This indicates that the user is able to add media content that will be linked to the selectable tab 170, and/or view previously uploaded media content associated with the selectable tab 170. In this example, the user may select icon 135. Accordingly, video content 160 may be either available for upload, or in another embodiment, the computing device 100 may display video content 160 (e.g., as a previously uploaded media content).

FIG. 1H illustrates an example interactive graphical user interface in an eighth state, in accordance with example embodiments. FIG. 1H shares one or more aspects in common with FIGS. 1A-1G. In this example, the selectable tab, hotspot 170 for “Masala Dosa” may be created and/or an existing hotspot may be selected. This indicates that the user is able to add media content that will be linked to the selectable tab 170, and/or view previously uploaded media content associated with the selectable tab 170. In this example, the user may select icon 145. Accordingly, link 175 may be either available for upload, or in another embodiment, the computing device 100 may display link 175 (e.g., as a previously uploaded link). The term “link” as used herein generally refers to a hyperlink, such as to an internet address.

FIG. 1I illustrates an example interactive graphical user interface in a ninth state, in accordance with example embodiments. FIG. 1I shares one or more aspects in common with FIGS. 1A-1H. Image 180 of a group photo is shown. In this example, three selectable tabs corresponding to three individuals in image 180 are shown, hotspots 185A, 185B, and 185C. One or more of these hotspots may be created and/or may be an existing hotspot that can be selected. This indicates that the user is able to add media content that will be linked to one or more of the hotspots 185A, 185B, and 185C, and/or view previously uploaded media content associated with the one or more of the hotspots 185A, 185B, and 185C. In this example, the user may select icon 125. Accordingly, textual description 150 may be either available for upload, or in another embodiment, the computing device 100 may display textual description 150 (e.g., as a previously uploaded media content). For example, textual description 150 may indicate that an individual “Rocky” tagged as hotspot 185A is a “PHP Developer.”

FIG. 1J illustrates an example interactive graphical user interface in a tenth state, in accordance with example embodiments. FIG. 1J shares one or more aspects in common with FIGS. 1A-1I. In this example, three selectable tabs corresponding to three individuals in image 180 are shown, hotspots 185A, 185B, and 185C. One or more of these hotspots may be created and/or may be an existing hotspot that can be selected. This indicates that the user is able to add media content that will be linked to one or more of the hotspots 185A, 185B, and 185C, and/or view previously uploaded media content associated with the one or more of the hotspots 185A, 185B, and 185C. In this example, the user may select icon 130. Accordingly, images 155 may be either available for upload, or in another embodiment, the computing device 100 may display images 155 (e.g., as a previously uploaded media content).

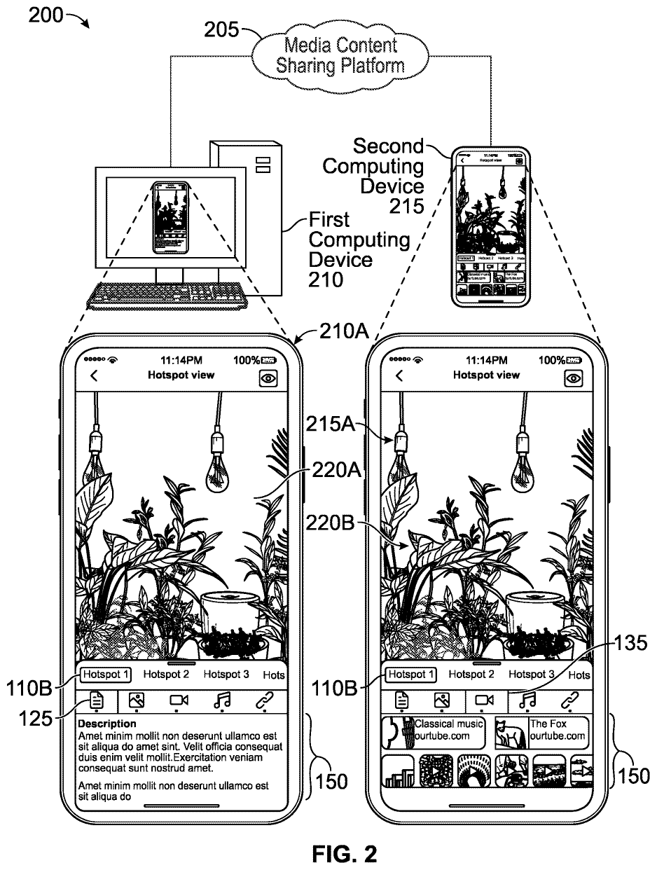

FIG. 2 illustrates a media content sharing environment 200, in accordance with example embodiments. Media content sharing environment 200 can include a media content sharing platform 205 (e.g., a cloud server) in communication with a first computing device 210 and a second computing device 215. As illustrated, media content sharing platform 205 may synchronize sharing of annotated images, hotspots, uploaded media content and the like across multiple users and/or devices. Any updates made at one computing device may be simultaneously synchronized across multiple users and/or devices. Also, for example, multiple users may be able to annotate the same image, and/or view uploaded media content simultaneously. For example, a family may be on vacation and one member may take a group photo and share it with family and friends. Different members of the family on vacation can then annotate the shared group photo with their own comments, anecdotes, jokes, stories, media content, etc. adding layers of meaningful content to the same image. Accordingly, the same two-dimensional (2D) image takes on a multi-dimensional existence via a shared, underlying layered data structure. Even those that are not on the trip but have access to the shared group photo can add their media content. Although existing image sharing application programs allow users to simultaneously share comments, “likes” etc., they lack the ability to add multiple hotspots at various portions of the image, and/or add media content associated with these various hotspots.

Referring to FIG. 2, an expanded view of an interactive GUI 210A associated with the first computing device 210, and an expanded view of an interactive GUI 215A associated with the second computing device 215, are shown. Both GUIs 210A and 215A are shown to display similar copies, respectively 220A and 220B, of the same image.

In some embodiments, a first user associated with the first computing device 210 may select the selectable tab 110B for “Hotspot 1.” As previously described with reference to FIG. 1B, this may indicate that the first user is able to add media content that will be linked to “Hotspot 1” (e.g., hotspot 110A of FIG. 1A), and/or view previously uploaded media content associated with “Hotspot 1.” In this example, the first user may select icon 125. Accordingly, textual description 150 may be either available for upload, or in another embodiment, the first computing device 210 and/or the second computing device 215 (based on respective access restrictions) may display textual description 150 (e.g., as a previously uploaded media content). Once uploaded, the media content sharing platform makes textual description 150 available to a second user associated with the second computing device 215.

In some embodiments, a second user associated with the second computing device 215 may select the selectable tab 110B for “Hotspot 1.” As previously described with reference to FIG. 1D, this may indicate that the first user is able to add media content that will be linked to “Hotspot 1” (e.g., hotspot 110A of FIG. 1A), and/or view previously uploaded media content associated with “Hotspot 1.” In this example, the second user may select icon 135. Accordingly, video content 160 may be either available for upload, or in another embodiment, the first computing device 210 and/or the second computing device 215 (based on respective access restrictions) may provide video content 160 (e.g., as a previously uploaded media content). Once uploaded, the media content sharing platform makes video content 160 available to the first user associated with the first computing device 210.

Although FIG. 2 illustrates with two specific examples, other combinations and permutations for hotspots, users, media content, view/upload, and so forth are contemplated.

### Example Applications

A number of example applications are now described. These examples are for illustrative purposes only, and in no way limiting the scope of the present description. A number of enterprise applications are contemplated. For example, applications can include annotated images for the design of garments, manufacturing products, architectural designs for real estate, engineering design models, and so forth. Also, for example, applications can include annotated images for instruction manuals, owner manuals, repair manuals, do-it-yourself (DIY) projects, and so forth, for various products. Such enterprise applications and/or content sharing platforms (e.g., media content sharing platform 205) may be provided as an application programming interface (API), an application-specific integrated circuit (ASIC), as a service (e.g., Software as a Service (Saas), Analytics as a Service (AnaaS), Platform as a Service (PaaS), Knowledge as a Service (KaaS), and so forth.

Although the embodiments described herein are with reference to a two-dimensional display device, other embodiments may involve virtual reality (VR) applications. For example, the media content may be provided via a VR platform, and users may be enabled to interact with the media content in VR. In some embodiments, such interactions may be in real-time. Also, for example, users may collaborate in a VR platform via respective virtual persona to annotate media content. For example, the VR platform may be configured to provide a collaborative space where one or more users may share the space to annotate and/or share media content.

In some embodiments, the media content may be provided via an augmented reality (AR) environment, and users may be enabled to interact with the media content in the AR environment. For example, an image or video may be projected onto a three-dimensional (3D) space, and a user may be able to interact with the image to add annotations. In such situations, the image may be a 3D image or video.

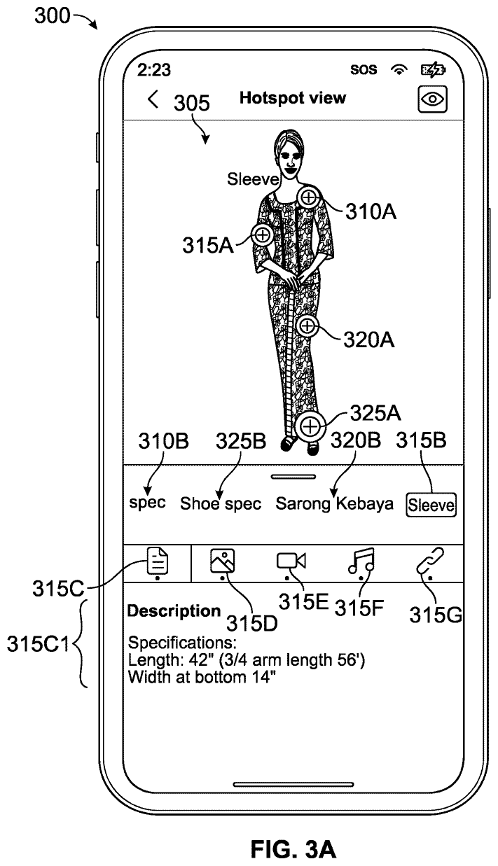

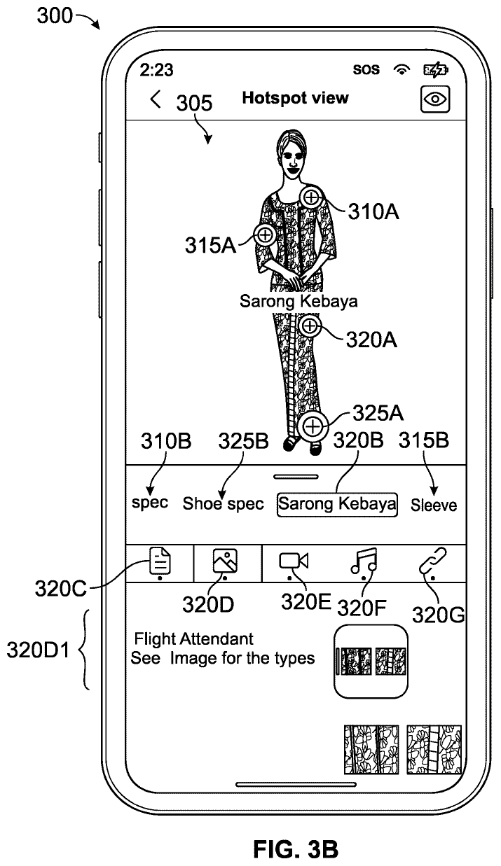

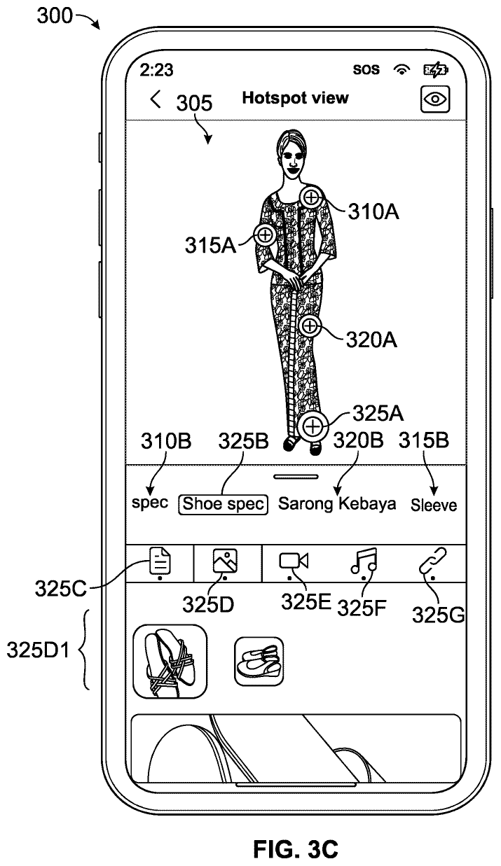

FIG. 3A illustrates an example interactive graphical user interface for design specifications in a first state, in accordance with example embodiments. Computing device 300 can include an interactive graphical user interface (GUI) that displays annotated image 305. For example, annotated image 305 may illustrate a garment design, such as a design for a uniform. One or more aspects of the garment may be annotated. For example, annotated image 305 may include one or more selectable virtual graphical objects located at respective portions of the annotated image 305. The one or more selectable virtual graphical objects may include a first selectable virtual graphical object representing the spec 310A, a second selectable virtual graphical object representing the sleeve 315A, a third selectable virtual graphical object representing the sarong kebaya 320A, and a fourth selectable virtual graphical object representing the shoe spec 325A.

In some embodiments, each of the selectable virtual graphical objects may be associated with a corresponding tab displayed below the image, such as a first tab titled “spec” 310B, a second tab titled “shoe spec” 325B, a third tab titled “sarong kebaya” 320B, and a fourth tab titled “sleeve” 315B. For example, when a user selects the second selectable virtual graphical object representing the sleeve 315A, the corresponding fourth tab titled “sleeve” 315B may be highlighted to indicate the selection.

In some embodiments, each of the selectable virtual graphical objects may be associated with a plurality of selectable tabs which may be displayed below the image. Each tab of the plurality of selectable tabs may be linked to a media content associated with the particular portion. For example, the second selectable virtual graphical object representing the sleeve 315A may be associated with a first tab 315C that displays information 315C1 related to the sleeve (e.g., a length of the sleeve, a width at the bottom of the sleeve, etc.) in textual format. The first tab 315C is denoted with a filled-in circle under the image for the icon, where the filled-in circle indicates that textual information is available for the sleeve. Also, for example, a second tab 315D can be associated one or more images for the sleeve, a third tab 315E can be associated one or more videos for the sleeve, a fourth tab 315F can be associated with audio content related to the sleeve, and a fifth tab 315G can be associated with a link (e.g., a URL) related to the sleeve. In this example, the icons for the tabs 315D-G do not have a filled-in circle under them, indicating an absence of the corresponding media content for the sleeve.

FIG. 3B illustrates an example interactive graphical user interface for design specifications in a second state, in accordance with example embodiments. FIG. 3B shares one or more aspects in common with FIG. 3A. In this example, the third selectable virtual graphical object representing the sarong kebaya 320A may be selected. Accordingly, third tab titled “sarong kebaya” 320B may be highlighted to indicate the selection. The third selectable virtual graphical object representing the sarong kebaya 320A may be associated with a first tab 320C that displays information related to the sarong kebaya in textual format. The first tab 320C is denoted with a filled-in circle under the image for the icon, where the filled-in circle indicates that textual information is available for the sarong kebaya. Also, for example, a second tab 320D can be associated with one or more images for the sarong kebaya. The second tab 320D is also denoted with a filled-in circle under the image for the icon, where the filled-in circle indicates that one or more images 320D1 are available for the sarong kebaya. The images 320D1 may be displayed and the user may select an image to further review it (e.g., in a separate window, as a pop-up, etc.), the user may interact with the image (e.g., zoom-in, zoom-out, etc.). Additional and/or alternative user interactions are possible. Also, for example, a third tab 320E can be associated one or more videos for the sarong kebaya, a fourth tab 320F can be associated with audio content related to the sarong kebaya, and a fifth tab 320G can be associated with a link (e.g., a URL) related to the sarong kebaya.

FIG. 3C illustrates an example interactive graphical user interface for design specifications in a third state, in accordance with example embodiments. FIG. 3C shares one or more aspects in common with FIGS. 3A-3B. In this example, the fourth selectable virtual graphical object representing the shoe spec 325A may be selected. Accordingly, a second tab titled “shoe spec” 325B may be highlighted to indicate the selection. The fourth selectable virtual graphical object representing the shoe spec 325A may be associated with a first tab 325C that displays information related to the shoe in textual format. The first tab 325C is denoted with a filled-in circle under the image for the icon, where the filled-in circle indicates that textual information is available for the shoe. Also, for example, a second tab 325D can be associated with one or more images for the show. The second tab 325D is also denoted with a filled-in circle under the image for the icon, where the filled-in circle indicates that one or more images 325D1 are available for the shoe. The images 325D1 may be displayed and the user may select an image to further review it (e.g., in a separate window, as a pop-up, etc.), the user may interact with the image (e.g., zoom-in, zoom-out, etc.). Additional and/or alternative user interactions are possible. Also, for example, a third tab 325E can be associated one or more videos for the shoe, a fourth tab 325F can be associated with audio content related to the shoe, and a fifth tab 325G can be associated with a link (e.g., a URL) related to the shoe.

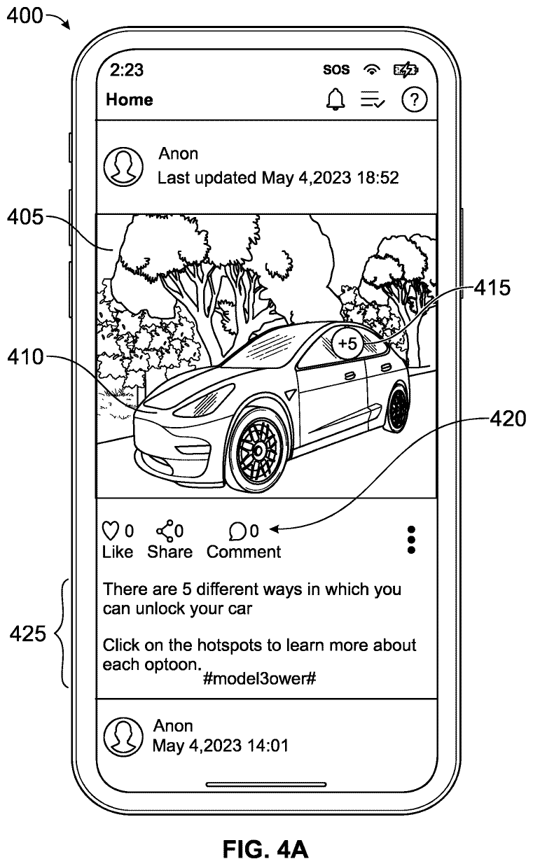

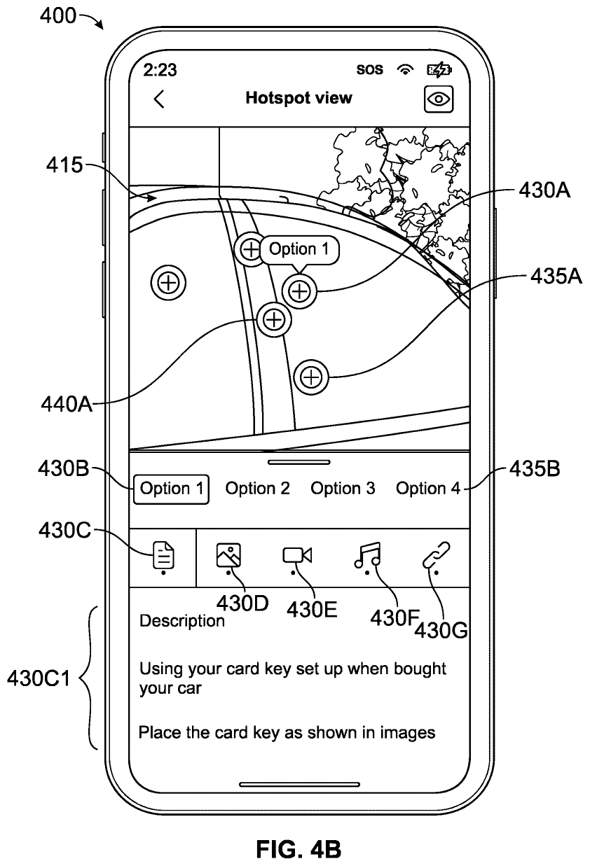

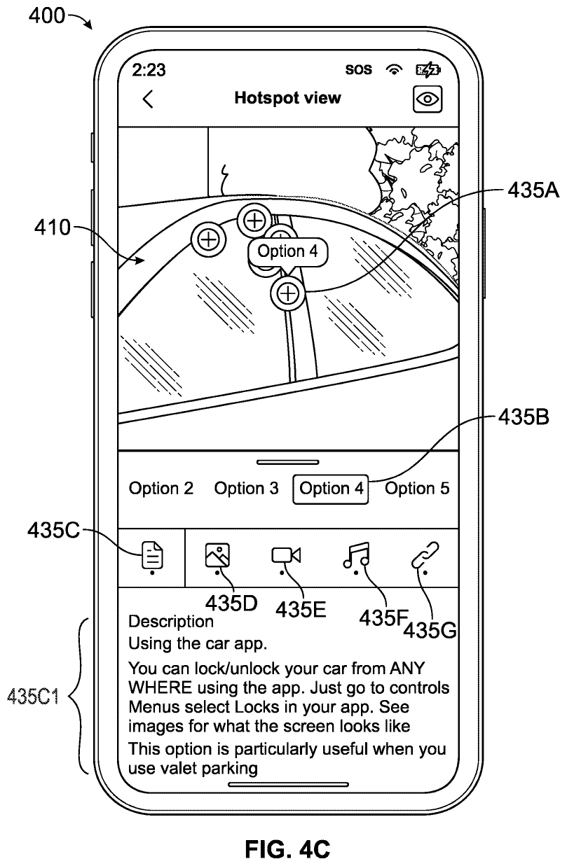

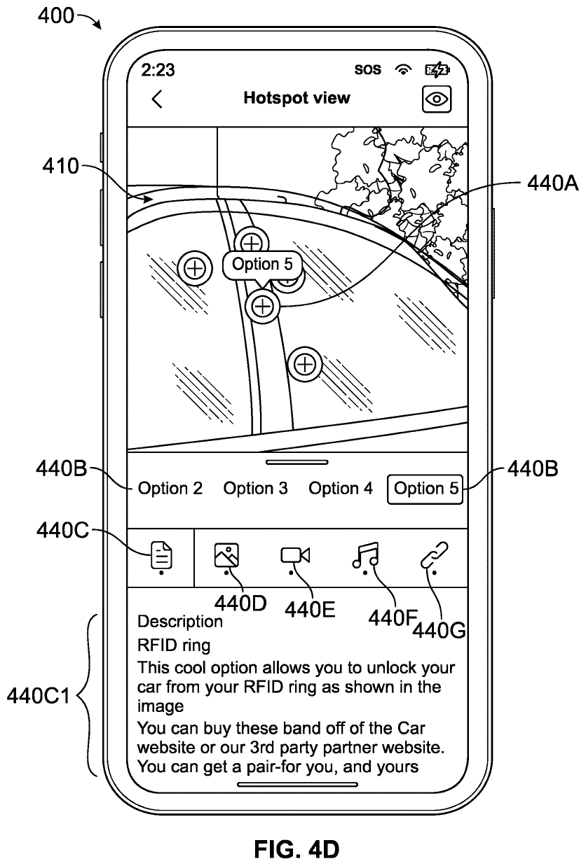

FIG. 4A illustrates an example interactive graphical user interface for an automotive instruction manual in a first state, in accordance with example embodiments. Computing device 400 can include an interactive graphical user interface (GUI) that displays annotated image 405 that includes a product, such as a car 410. For example, annotated image 405 may illustrate an image from a product manual, a repair manual, an instructions manual, and so forth. Oftentimes, such manuals are packed with textual information and schematic diagrams, that makes it difficult for a user to quickly sift through the information in an easy, user-friendly manner. Accordingly, there is a need to summarize this information in an easily accessible manner, with images, videos, etc. that aid and/or guide the user in a practical manner.

For example, the user may need to adjust the tire pressure for a car tire. Accordingly, the user can view an annotated image of the car, locate a “hotspot” indicating the tire, and click on the hotspot to view media content that explains what the correct tire pressure is, and/or how to adjust the tire pressure. Similarly, the user may need to change a car tire. Accordingly, the user can view an annotated image of the car, locate a “hotspot” indicating the tire, and click on the hotspot to view media content that indicates the type of tire, and explains how to change the tire. In some embodiments, the user may be provided with links to nearby tire changing services, information and/or links for a tow service, and so forth.

As indicated in FIG. 4A, annotated image 405 may include one or more selectable virtual graphical objects located at respective portions of the annotated image 405. For example, a selectable virtual graphical object with a label “+5” 415 may indicate that there are five hotspots associated with the annotated image 405. In some embodiments, annotated image 405 may be a social media post by a user, and portion 420 may indicate various quantitative measurements of user engagement (e.g., a number of likes, a number of shares, a number of comments, and so forth). Portion 425 provides additional information about the annotated image 405, such as an indication that there are five options to unlock the car, and that the user may click on the hotspots with a label “+5” 415 to obtain more information about each option.

FIG. 4B illustrates an example interactive graphical user interface for an automotive instruction manual in a second state, in accordance with example embodiments. FIG. 4B shares one or more aspects in common with FIG. 4A. For example, a user may select the label “+5” 415 of FIG. 4A, thereby causing the interactive graphical user interface to transition from the first state to the second state. Car 410 is now displayed with the five selectable virtual graphical objects or hotspots represented by plus symbols. The one or more selectable virtual graphical objects may include a first selectable virtual graphical object representing a first option, Option 1, 430A, a second selectable virtual graphical object representing a fourth option, Option 4, 435A, and a third selectable virtual graphical object representing a fifth option, Option 5, 440A. Additional options labeled “Option 2” and “Option 3” are shown.

In some embodiments, each of the selectable virtual graphical objects may be associated with a corresponding tab displayed below the image, such as a first tab titled “Option 1” 430B, and a second tab titled “Option 4” 435B. Additional tabs corresponding to other options may also appear. Also, for example, although the third selectable virtual graphical object representing a fifth option, Option 5, 440A is displayed, the corresponding tab for “option 5” may not be displayed. A user may swipe the tabs to reveal additional tabs. For example, in one display, tabs for “Option 1” to “Option 4” may be displayed, and after the user swipes the tabs, tabs for “Option 2” to “Option 5” may be displayed. Additional and/or alternative ways of displaying the tabs are possible. When a user selects the first selectable virtual graphical object representing a first option, Option 1, 430A, the corresponding first tab titled “Option 1” 430B may be highlighted to indicate the selection.

In some embodiments, each of the selectable virtual graphical objects may be associated with a plurality of selectable tabs which may be displayed below the image. Each tab of the plurality of selectable tabs may be linked to a media content associated with the particular portion. For example, the first selectable virtual graphical object representing a first option, Option 1, 430A may be associated with a first tab 430C that displays information 430C1 related to the Option 1 in textual format. The first tab 430C is denoted with a filled-in circle under the image for the icon, where the filled-in circle indicates that textual information is available for Option 1. Also, for example, a second tab 430D can be associated one or more images for Option 1, a third tab 430E can be associated one or more videos for Option 1, a fourth tab 430F can be associated with audio content related to Option 1, and a fifth tab 430G can be associated with a link (e.g., a URL) related to Option 1. In this example, the icons for the tabs 430F-G do not have a filled-in circle under them, indicating an absence of the corresponding media content for Option 1. However, the icons for the tabs 430C-E have a filled-in circle under them, indicating a presence of the corresponding media content for Option 1.

FIG. 4C illustrates an example interactive graphical user interface for an automotive instruction manual in a third state, in accordance with example embodiments. FIG. 4C shares one or more aspects in common with FIGS. 4A-4B. In this example, the second selectable virtual graphical object representing a fourth option, Option 4, 435A may be selected. Accordingly, a second tab titled “Option 4” 435B may be highlighted to indicate the selection. The second selectable virtual graphical object representing a fourth option, Option 4, 435A may be associated with a first tab 435C that displays information 435C1 related to the Option 4 in textual format. The first tab 435C is denoted with a filled-in circle under the image for the icon, where the filled-in circle indicates that textual information is available for Option 4. Also, for example, a second tab 435D can be associated one or more images for Option 4, a third tab 435E can be associated one or more videos for Option 4, a fourth tab 435F can be associated with audio content related to Option 4, and a fifth tab 435G can be associated with a link (e.g., a URL) related to Option 4. In this example, the icons for the tabs 435F-G do not have a filled-in circle under them, indicating an absence of the corresponding media content for Option 4. However, the icons for the tabs 435C-E have a filled-in circle under them, indicating a presence of the corresponding media content for Option 4.

FIG. 4D illustrates an example interactive graphical user interface for an automotive instruction manual in a fourth state, in accordance with example embodiments. FIG. 4D shares one or more aspects in common with FIGS. 4A-4C. In this example, the third selectable virtual graphical object representing a fifth option, Option 5, 440A may be selected. Accordingly, the third tab titled “Option 5” 440B may be highlighted to indicate the selection. The third selectable virtual graphical object representing a fifth option, Option 5, 440A may be associated with a first tab 440C that displays information 440C1 related to the Option 5 in textual format. The first tab 440C is denoted with a filled-in circle under the image for the icon, where the filled-in circle indicates that textual information is available for Option 4. Also, for example, a second tab 440D can be associated one or more images for Option 5, a third tab 440E can be associated one or more videos for Option 5, a fourth tab 440F can be associated with audio content related to Option 5, and a fifth tab 440G can be associated with a link (e.g., a URL) related to Option 5. In this example, the icons for the tabs 440F-G do not have a filled-in circle under them, indicating an absence of the corresponding media content for Option 5. However, the icons for the tabs 440C-E have a filled-in circle under them, indicating a presence of the corresponding media content for Option 5.

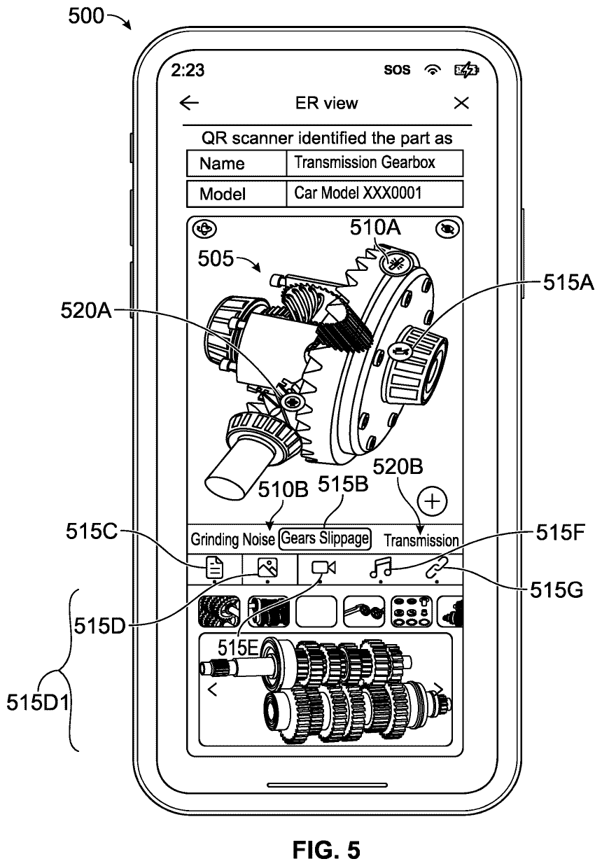

FIG. 5 illustrates an example interactive graphical user interface for an automotive repair manual, in accordance with example embodiments. Computing device 500 can include an interactive graphical user interface (GUI) that displays annotated image 505. For example, annotated image 505 may illustrate an automotive part, such as a part that is in need of repair. One or more aspects of the automotive part may be annotated. For example, annotated image 505 may include one or more selectable virtual graphical objects located at respective portions of the annotated image 505. The one or more selectable virtual graphical objects may include a first selectable virtual graphical object representing a source 510A of a grinding noise, a second selectable virtual graphical object representing gear slippage 515A, and a third selectable virtual graphical object representing the transmission 520A.

In some embodiments, each of the selectable virtual graphical objects may be associated with a corresponding tab displayed below the image, such as a first tab titled “Grinding Noise” 510B, a second tab titled “Gears Slippage” 515B, and a third tab titled “Transmission” 520B. For example, when a user selects the second selectable virtual graphical object representing gear slippage 515A, the corresponding second tab titled “Gears Slippage” 515B may be highlighted to indicate the selection.

In some embodiments, each of the selectable virtual graphical objects may be associated with a plurality of selectable tabs which may be displayed below the image. Each tab of the plurality of selectable tabs may be linked to a media content associated with the particular portion. For example, the second selectable virtual graphical object representing gear slippage 515A may be associated with a first tab 515C that displays information related to gear slippage in textual format. Also, for example, a second tab 515D can be associated one or more images 515D1 illustrating gear slippage, a third tab 515E can be associated one or more videos illustrating gear slippage, a fourth tab 515F can be associated with audio content related to gear slippage, and a fifth tab 515G can be associated with a link (e.g., a URL) related to gear slippage. In this example, the icons for the tab 515G does not have a filled-in circle under it, indicating an absence of the corresponding media content for gear slippage. However, the icons for the tabs 515C-F have a filled-in circle under them, indicating a presence of the corresponding media content related to gear slippage.

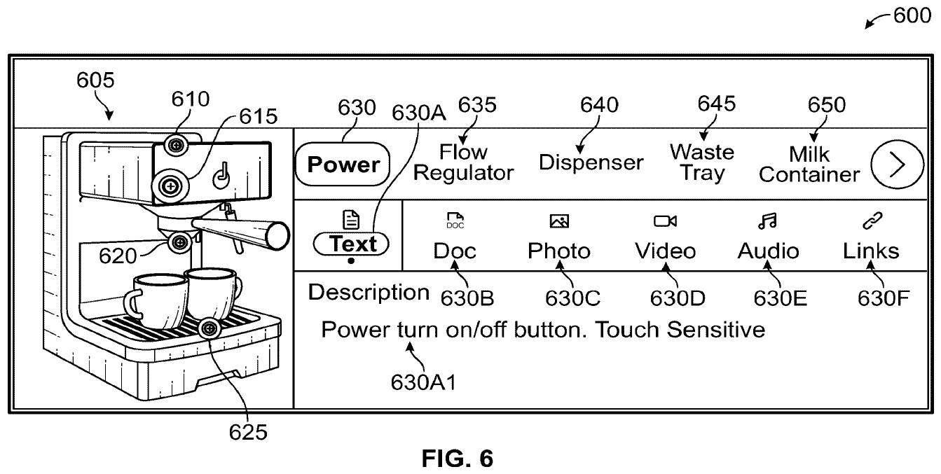

FIG. 6 illustrates an example interactive graphical user interface associated with displaying a three-dimensional (3D) image, in accordance with example embodiments. Computing device 600 can include an interactive graphical user interface (GUI) that displays annotated 3D image 605. A user may be able to interact with annotated 3D image 605, for example by rotating, zooming in and out, panning, adding and/or deleting hotspots, and so forth. In some embodiments, annotated 3D image 605 may illustrate various operations and/or parts of a coffee machine. One or more aspects of the coffee machine may be annotated. For example, annotated 3D image 605 may include one or more selectable virtual graphical objects located at respective portions of the annotated 3D image 605. The one or more selectable virtual graphical objects may include a first selectable virtual graphical object 610, a second selectable virtual graphical object 615, a third selectable virtual graphical object 620, and a fourth selectable graphical object 625.

In some embodiments, each of the selectable virtual graphical objects may be associated with a corresponding tab, such as a first tab 630 titled “Power,” a second tab 635 titled “Flow Regulator,” a third tab 640 titled “Dispenser,” a fourth tab 645 titled “Waste Tray,” and a fifth tab 650 titled “Milk Container.” For example, when a user selects the second selectable virtual graphical object 615, the corresponding first tab 630 titled “Power” may be highlighted to indicate the selection.

In some embodiments, each of the selectable virtual graphical objects may be associated with a plurality of selectable tabs which may be displayed by the GUI. Each tab of the plurality of selectable tabs may be linked to media content associated with the particular portion. For example, the second selectable virtual graphical object 615 may be associated with the first tab 630 that displays information related to power functions in textual format. For example, text 630A may correspond to a “Description” 630A1 indicating that the second selectable virtual graphical object 615 describes a “Power turn on/off button. Touch Sensitive.”

Also, for example, doc 630B can be associated with one or more documents, photo 630C can be associated with one or more images, video 630D can be associated with one or more videos, audio 630E can be associated with one or more audios, and links 630F can be associated with a link (e.g., a URL). In this example, the icon for text 630A has a filled-in circle under it, indicating a presence of a corresponding media content.

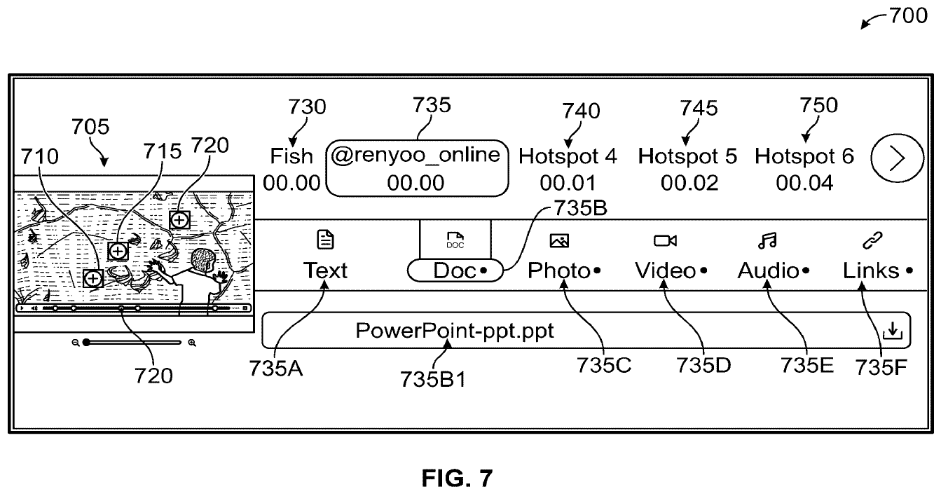

FIG. 7 illustrates an example interactive graphical user interface associated with displaying an annotated video, in accordance with example embodiments. Computing device 700 can include an interactive graphical user interface (GUI) that displays annotated video 705. A user may be able to interact with annotated video 705, for example by playing, rewinding, fast forwarding, zooming in and out, panning, adding and/or deleting hotspots, and so forth. Also, for example, annotated video 705 may include a timeline track with selectable labels 720 that enable a user to select and directly view the associated portion of the video. In some embodiments, annotated video 705 may be a video of an aquarium. One or more aspects of the video may be annotated. For example, annotated video 705 may include one or more selectable virtual graphical objects located at respective portions of the annotated video 705. The one or more selectable virtual graphical objects may include a first selectable virtual graphical object 710, a second selectable virtual graphical object 715, and a third selectable virtual graphical object 720.

In some embodiments, each of the selectable virtual graphical objects may be associated with a corresponding tab, such as a first tab 730 titled “Fish,” a second tab 735 titled “@renyoo_online,” a third tab 740 titled “Hotspot 4,”a fourth tab 745 titled “Hotspot 5,” and a fifth tab 750 titled “Hotspot 6.” For example, when a user selects the second selectable virtual graphical object 715, the corresponding second tab 735 titled “@renyoo_online” may be highlighted to indicate the selection.

In some embodiments, each of the selectable virtual graphical objects may be associated with a plurality of selectable tabs which may be displayed by the GUI. Each tab of the plurality of selectable tabs may be linked to media content associated with the particular portion. For example, the second selectable virtual graphical object 715 may be associated with the second tab 735 that provides a document. For example, doc 735B may correspond to a “PowerPoint-ppt.ppt” 735B1 indicating that the second selectable virtual graphical object 715 has additional associated information.

Also, for example, text 735A can be associated with text, photo 735C can be associated with one or more images, video 735D can be associated with one or more videos, audio 735E can be associated with one or more audios, and links 735F can be associated with a link (e.g., a URL). In this example, the icon for doc 735B has a filled-in circle next to it, indicating a presence of a corresponding media content. Similarly, icons for photo 735C, video 735D, audio 735E, and links 735F have respective filled-in circles next to them, indicating availability of additional media content, whereas text 735A does not have a filled-in circle next to it, indicating an absence of a corresponding media content.

### Example Data Network

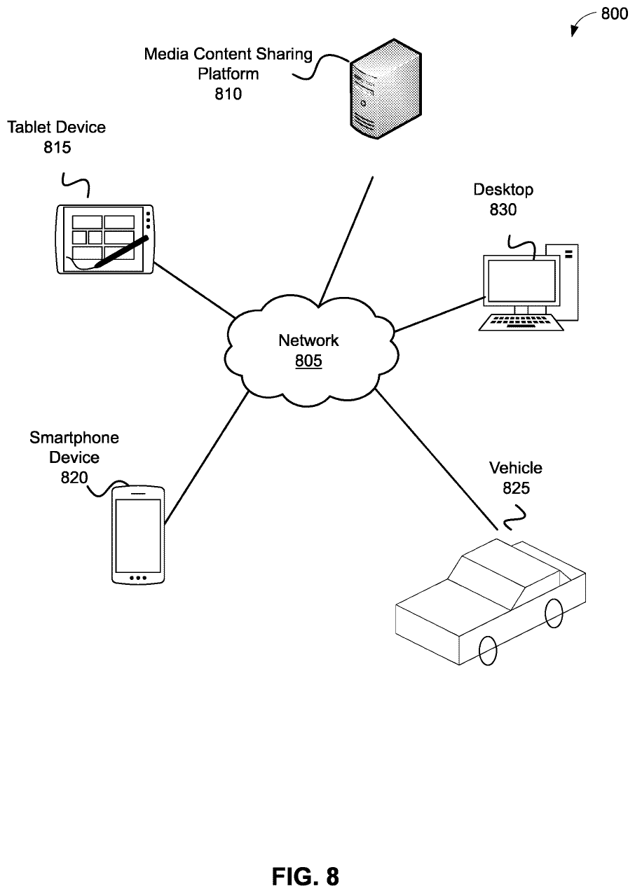

FIG. 8 depicts a distributed computing environment 800, in accordance with example embodiments. Distributed computing environment 800 includes a media content sharing platform 810 (e.g., a server device, a distributed system, a hybrid cloud, a cloud server, and so forth) that is configured to communicate, via network 805, with one or more computing devices, such as a tablet device 815, a smartphone device 820, a vehicle 825 equipped with a computing device, and a desktop. Network 805 may correspond to a local area network (LAN), a wide area network (WAN), a WLAN, a WWAN, an intranet, a public Internet, or any other type of network configured to provide a communications path between networked computing devices. Network 805 may also correspond to a combination of one or more networks.

It may be noted that these devices shown are for illustrative purposes only. Generally speaking, media content sharing platform 810 may be communicatively linked to a computing device over network 805. In fact, it may be linked to multiple computing devices (e.g., millions) in a distributed computing environment 800. In addition to the computing devices illustrated in FIG. 8, other devices such as mobile computing devices, wearable devices, head-mountable devices (HMD), AR devices, VR devices, aircrafts, boats, drones, and so on are possible. The devices may be directly connected to network 805, or may be indirectly connected to network 805 via another device that is directly connected.

Media content sharing platform 810 may share one or more aspects in common with media content sharing platform 205 of FIG. 2, and can be configured to perform one or more functions performed by a media sharing platform, in addition to the particular functions described herein.

### Example Computing Device

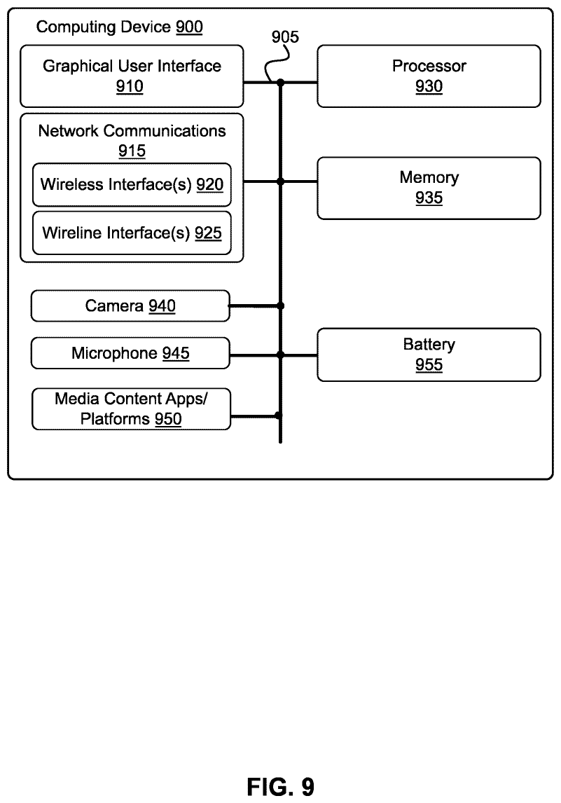

FIG. 9 is a block diagram of an example computing device 900, in accordance with example embodiments. In particular, computing device 900 shown in FIG. 9 can be configured to perform at least one function of and/or related to collaborative media content annotation and sharing, method 800, and/or method 900.

Computing device 900 may include modules to provide various functionalities, such as for example, a graphical user interface 910, network communications 915, a processor 930, memory 935, a camera 940, a microphone 945, media content apps/platforms 950, and battery 955, all of which may be linked together via a system bus, or other connection mechanism 905.

Graphical user interface 910 can be configured to send data to and/or receive data from external user input/output devices such as such as a touch screen, a computer mouse, a keyboard, a microphone, external monitors, and the like. Graphical user interface 910 can also be configured to generate audio and/or video outputs.

Network communications 915 can be configured to provide one or more wireless interface(s) 920 and/or one or more wireline interface(s) 925 that can be configured to communicate via a network (e.g., network 805 of FIG. 8). Wireless interface(s) 920 can include wireless transmitters, receivers, and/or transceivers (e.g., for Bluetooth, Wi-Fi, near-field communications, etc.). Wireline interface(s) 925 can include wireline transmitters, receivers, and/or transceivers (e.g., Ethernet transceiver).

In some examples, network communications 915 can be configured to provide reliable, secured, and/or authenticated communications. For example, network communications 915 can be configured to provide encrypted data. The type of encryption may depend on a type of network interface, capabilities of a network itself, a type of data to be transmitted, and so forth.

Processor 930 can include a general purpose processor, and/or special purpose processors (e.g., digital signal processors, graphics processing units (GPUs), media processing processors, image processing processors, text processing processors, speech processing processors, etc.). Processor 930 can be configured to execute computer-readable instructions that are contained in memory 935 and/or other instructions as described herein.

Memory 935 can include one or more non-transitory computer-readable storage media that can be read and/or accessed by processor 930. The one or more computer-readable storage media can include volatile and/or non-volatile storage components. In some examples, memory 935 can be implemented using a single physical device, while in other examples, memory 935 can be implemented using multiple physical devices.

memory 935 can include computer-readable instructions that, when executed by processor 930, enable computing device 900 to provide for some or all of the functionality of the computing devices and/or media content sharing platforms described herein.

In some examples, computing device 900 can include camera 940. Camera 940 can include still and/or video cameras.

In some examples, computing device 900 can include microphone 945. Microphone 945 can be configured to capture audio inputs (e.g., speech, music, and so forth).

In some examples, computing device 900 can include media content apps/platforms 950. Media content apps/platforms 950 may be configured to share media content, enable recording or playback of shared media content, create and/or share annotated images as described herein.

Battery 955 may be configured to provide electrical power to computing device 900. Each battery can, when electrically coupled to the computing device 900, act as a source of stored electrical power for computing device 900. Battery 955 may be one or more of portable, removable, rechargeable, etc. The term battery is generally used herein to denote a power supply (wired or otherwise).

### Example Methods of Operation

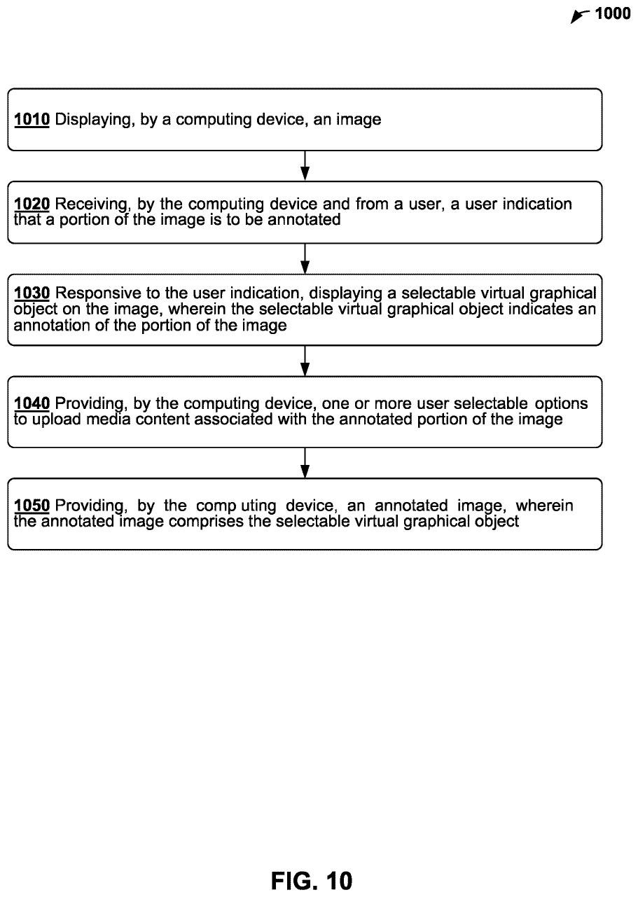

FIG. 10 is a flowchart of a method for collaborative media content annotation and sharing, in accordance with example embodiments. Method 1000 can be executed by a computing device, such as computing device 900. Method 1000 can begin at block 1010, where the method 1000 involves displaying, by computing device 900, an image.

At block 1020, the method 800 involves receiving, by the computing device 900 and from a user, a user indication that a portion of the image is to be annotated.

At block 1030, the method 1000 involves responsive to the user indication, displaying a selectable virtual graphical object on the image, wherein the selectable virtual graphical object indicates an annotation of the portion of the image.

At block 1040, the method 1000 involves providing, by the computing device 900, one or more user selectable options to upload media content associated with the annotated portion of the image.

At block 1050, the method 1000 involves providing, by the computing device 900, an annotated image, wherein the annotated image comprises the selectable virtual graphical object.

Some embodiments involve detecting, by the computing device, a selection of the one or more user selectable options. Such embodiments also involve receiving, by the computing device, a media content uploaded in response to the selection of the one or more user selectable options. Such embodiments further involve associating the received media content with the selectable virtual graphical object. The selectable virtual graphical object may include a link to the received media content.

Some embodiments involve detecting a selection of the selectable virtual graphical object. Such embodiments also involve, in response to the detecting, providing the received media content.

Some embodiments involve sharing, by the computing device, the annotated image with one or more additional users.

Some embodiments involve receiving, by the computing device, respective one or more user credentials associated with the one or more additional users, wherein the one or more user credentials indicate that the one or more additional users are authorized to access the annotation of the portion of the image. The providing of the annotated image may be restricted to the one or more additional users authorized to access the annotation of the portion of the image.

Some embodiments involve synchronizing the annotated image with content stored at a remote server. Such embodiments also involve updating the shared content for the one or more additional users.

Some embodiments involve receiving, by the computing device and from the user, a second user indication that a second portion of the image is to be annotated. Such embodiments also involve, responsive to the second user indication, causing a second virtual graphical object to be displayed on the image, wherein the second virtual graphical object indicates an annotation of the second portion of the image.

Some embodiments involve receiving, by the computing device and from a second user, a second user indication that the portion of the image is to be annotated. Such embodiments also involve, responsive to the second user indication, causing a second virtual graphical object to be displayed on the image, wherein the second virtual graphical object indicates a second annotation of the portion of the image.

Some embodiments involve receiving, by the computing device and from the second user, a third user indication that a second portion of the image is to be annotated. Such embodiments also involve, responsive to the third user indication, causing a third virtual graphical object to be displayed on the image, wherein the third virtual graphical object indicates an annotation of the second portion of the image.

In some embodiments, the computing device may be configured with a software application program that implements the collaborative media content annotation and sharing.

In some embodiments, the media content associated with the annotated portion of the image may include one or more of a textual description, another image, a video content, a universal resource locator, or an audio content.

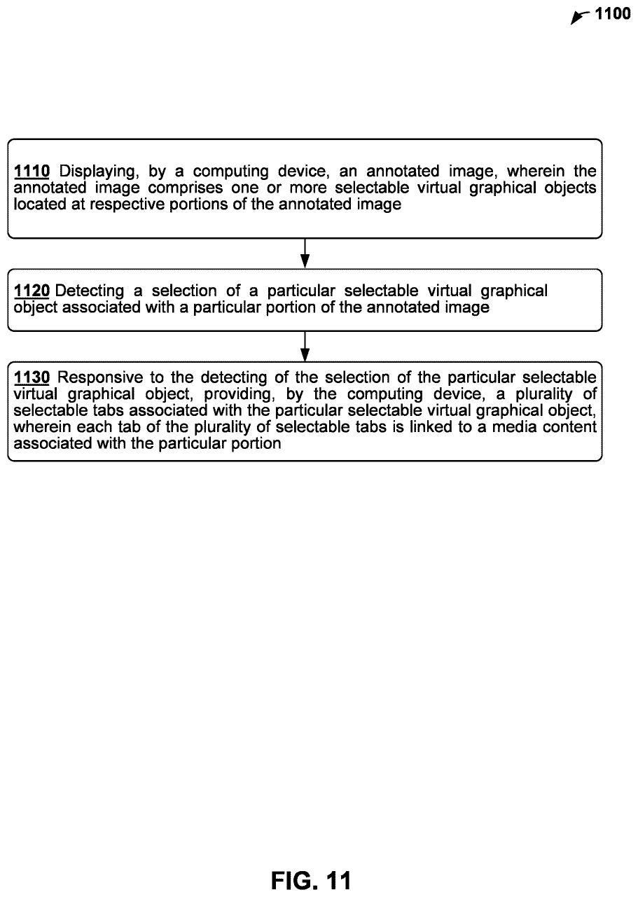

FIG. 11 is a flowchart of a method for displaying annotated images, in accordance with example embodiments. Method 1100 can be executed by a computing device, such as computing device 900. Method 1100 can begin at block 1110, where the method 1100 involves displaying, by computing device 900, an annotated image, wherein the annotated image comprises one or more selectable virtual graphical objects located at respective portions of the annotated image.

At block 1120, the method 1100 involves detecting a selection of a particular selectable virtual graphical object associated with a particular portion of the annotated image.

At block 1130, the method 1100 involves responsive to the detecting of the selection of the particular selectable virtual graphical object, providing, by computing device 900, a plurality of selectable tabs associated with the particular selectable virtual graphical object, wherein each tab of the plurality of selectable tabs is linked to a media content associated with the particular portion.

Some embodiments involve detecting, by the computing device, a selection of a selectable tab of the plurality of selectable tabs. Such embodiments also involve, responsive to the detecting of the selection of the selectable tab, providing, by the computing device, the linked media content associated with the selected selectable tab.

In some embodiments, the computing device may be configured with a software application program that implements the displaying of the annotated images.

In some embodiments, the linked media content associated with the particular portion may include one or more of a textual description, another image, a video content, a universal resource locator, or an audio content.

In some embodiments, the annotated images may be provided by an enterprise platform.

In some embodiments, the enterprise platform may be associated with an apparel design provider. The displayed annotated image may correspond to a design of an apparel. The one or more selectable virtual graphical objects may correspond to respective portions of the apparel. The linked media content associated with the particular portion may relate to a design feature of the particular portion of the apparel. In some embodiments, the apparel may be a uniform outfit for an individual at an organization. In some embodiments, the organization may be an airline, and the individual may be one or more of a flight attendant, a pilot, a ground crew, or a service representative. In some embodiments, the organization is a school, and the individual is a student attending the school. In some embodiments, the organization may be an armed services organization, and the individual is a service personnel at the armed services organization.

In some embodiments, the enterprise platform may be associated with a commercial product. The displayed annotated image may be an illustration of the commercial product. The one or more selectable virtual graphical objects may correspond to respective portions of the commercial product. The linked media content associated with the particular portion may relate to a feature of the particular portion of the commercial product. In some embodiments, the commercial product may be an automobile. The one or more selectable virtual graphical objects may correspond to respective portions of the automobile. The linked media content associated with the particular portion may relate to one or more of a functional feature, or a product specification, of the particular portion of the automobile.

In some embodiments, the enterprise platform may be configured to provide an instruction manual for a product. The displayed annotated image may be an illustration from the instruction manual for the product. The linked media content associated with the particular portion may relate to one or more instructions related to the particular portion of the illustration.

In some embodiments, the enterprise platform may be configured to provide a repair manual for a product. The displayed annotated image may be an illustration from the repair manual for the product. The linked media content associated with the particular portion may relate to one or more repair instructions related to the particular portion of the illustration.

### Example Systems

A system for collaborative media content annotation and sharing is provided. The system includes a first computing device, and a second computing device. The system also includes one or more processors, and data storage. The data storage has stored thereon computer-executable instructions that, when executed by the one or more processors, cause the one or more processors to carry out functions. The functions include: receiving, from the first computing device, a user indication that a portion of an image is to be annotated; responsive to the receiving of the user indication, causing the first computing device to display a selectable virtual graphical object on the image, wherein the selectable virtual graphical object indicates an annotation of the portion of the image; causing the first computing device to display one or more user selectable options to upload media content associated with the annotated portion of the image; and providing, to the first computing device and the second computing device, an annotated image, wherein the annotated image comprises the selectable virtual graphical object.

Some embodiments involve receiving, from the first computing device, a media content uploaded in response to a selection of the one or more user selectable options. Such embodiments also involve associating the uploaded media content with the selectable virtual graphical object. Such embodiments further involve causing the selectable virtual graphical object to be associated with a link to the uploaded media content.

Some embodiments involve receiving, from the second computing device, an indication of a selection of the selectable virtual graphical object. Such embodiments also involve, in response to the receiving, causing the second computing device to provide the uploaded media content.

Some embodiments involve causing the annotated image to be shared with one or more additional users.

Some embodiments involve receiving, from the first computing device, respective one or more user credentials associated with the one or more additional users, wherein the one or more user credentials indicate that the one or more additional users are authorized to access the annotation of the portion of the image. The providing of the annotated image may be restricted to the one or more additional users authorized to access the annotation of the portion of the image.

Some embodiments involve synchronizing one or more updates to the annotated image across the first and second computing devices, wherein the one or more updates comprise addition of another selectable virtual graphical object, and/or uploading of another media content.

Some embodiments involve receiving, from the first computing device, a second user indication that a second portion of the image is to be annotated. Such embodiments also involve, responsive to the second user indication, causing the first and second computing devices to display a second virtual graphical object on the image, wherein the second virtual graphical object indicates an annotation of the second portion of the image.

Some embodiments involve receiving, from the second computing device, a second user indication that the portion of the image is to be annotated. Such embodiments also involve, responsive to the second user indication, causing the first and second computing devices to display a second virtual graphical object on the image, wherein the second virtual graphical object indicates a second annotation of the portion of the image.

Some embodiments involve receiving, from the second computing device, a third user indication that a second portion of the image is to be annotated. Such embodiments also involve, responsive to the third user indication, causing the first and second computing devices to display a third virtual graphical object on the image, wherein the third virtual graphical object indicates an annotation of the second portion of the image.

Some embodiments involve receiving, from the first computing device, a request to download a software application program that implements the collaborative media content annotation and sharing. Such embodiments also involve, in response to the receiving of the request, providing the first computing device with an executable version of the software application program.

In some embodiments, the first computing device may include an image capturing device, and wherein the image may be captured by the image capturing device.

In some embodiments, the media content associated with the annotated portion of the image may include a textual description, and wherein the textual description may be generated by a text editor of one or more of the first or second computing devices.

In some embodiments, the media content associated with the annotated portion of the image may include another image, and wherein the other image may be generated by an image capturing device of one or more of the first or second computing devices.

In some embodiments, the media content associated with the annotated portion of the image may include a video content, and wherein the video content may be generated by a video capturing device of one or more of the first or second computing devices.

In some embodiments, the media content associated with the annotated portion of the image may include an audio content, and wherein the video content may be generated by an audio capturing device of one or more of the first or second computing devices.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

1. A computer-implemented method for collaborative media content annotation and sharing, comprising:
displaying, by a computing device, an image;
receiving, by the computing device and from a user, a user indication that a portion of the image is to be annotated;
responsive to the user indication, displaying a selectable virtual graphical object on the image, wherein the selectable virtual graphical object indicates an annotation of the portion of the image;
providing, by the computing device, one or more user selectable options to upload media content associated with the annotated portion of the image; and
providing, by the computing device, an annotated image, wherein the annotated image comprises the selectable virtual graphical object.

2. The computer-implemented method of claim 1, further comprising:
detecting, by the computing device, a selection of the one or more user selectable options;
receiving, by the computing device, a media content uploaded in response to the selection of the one or more user selectable options;
associating the received media content with the selectable virtual graphical object, and
wherein the selectable virtual graphical object comprises a link to the received media content.

3. The computer-implemented method of claim 2, further comprising:
detecting a selection of the selectable virtual graphical object; and
in response to the detecting, providing the received media content.

4. The computer-implemented method of claim 1, further comprising:
sharing, by the computing device, the annotated image with one or more additional users.

5. The computer-implemented method of claim 4, further comprising:
synchronizing the annotated image with content stored at a remote server; and
updating the shared content for the one or more additional users.

6. The computer-implemented method of claim 1, further comprising:
receiving, by the computing device and from a second user, a second user indication that the portion of the image is to be annotated; and
responsive to the second user indication, causing a second virtual graphical object to be displayed on the image, wherein the second virtual graphical object indicates a second annotation of the portion of the image.

7. The computer-implemented method of claim 6, further comprising:
receiving, by the computing device and from the second user, a third user indication that a second portion of the image is to be annotated; and
responsive to the third user indication, causing a third virtual graphical object to be displayed on the image, wherein the third virtual graphical object indicates an annotation of the second portion of the image.

8. The computer-implemented method of claim 1, wherein the media content associated with the annotated portion of the image comprises one or more of a textual description, another image, a video content, a universal resource locator, or an audio content.

9. (canceled)

10. (canceled)

11. (canceled)

12. (canceled)

13. (canceled)

14. A media sharing system for collaborative media content annotation and sharing, comprising:
a first computing device;
a second computing device;
one or more processors; and
data storage, wherein the data storage has stored thereon computer-executable instructions that, when executed by the one or more processors, cause the one or more processors to carry out functions comprising:
receiving, from the first computing device, a user indication that a portion of an image is to be annotated;
responsive to the receiving of the user indication, causing the first computing device to display a selectable virtual graphical object on the image, wherein the selectable virtual graphical object indicates an annotation of the portion of the image;
causing the first computing device to display one or more user selectable options to upload media content associated with the annotated portion of the image; and
providing, to the first computing device and the second computing device, an annotated image, wherein the annotated image comprises the selectable virtual graphical object.

15. The system of claim 14, the operations further comprising:
receiving, from the first computing device, a media content uploaded in response to a selection of the one or more user selectable options;
associating the uploaded media content with the selectable virtual graphical object; and
causing the selectable virtual graphical object to be associated with a link to the uploaded media content.

16. The system of claim 14, the operations further comprising:
receiving, from the second computing device, an indication of a selection of the selectable virtual graphical object; and
in response to the receiving, causing the second computing device to provide the uploaded media content.

17. The system of claim 14, the operations further comprising:
causing the annotated image to be shared with one or more additional users.

18. The system of claim 14, the operations further comprising:
synchronizing one or more updates to the annotated image across the first and second computing devices, wherein the one or more updates comprise addition of another selectable virtual graphical object, and/or uploading of another media content.

19. The system of claim 14, the operations further comprising:
receiving, from the first computing device, a second user indication that a second portion of the image is to be annotated;
responsive to the second user indication, causing the first and second computing devices to display a second virtual graphical object on the image, wherein the second virtual graphical object indicates an annotation of the second portion of the image.

20. The system of claim 14, wherein the media content associated with the annotated portion of the image comprises a textual description, and wherein the textual description is generated by a text editor of one or more of the first or second computing devices.

21. A computer-implemented method for displaying annotated images, comprising:
displaying, by a computing device, an annotated image, wherein the annotated image comprises one or more selectable virtual graphical objects located at respective portions of the annotated image;
detecting a selection of a particular selectable virtual graphical object associated with a particular portion of the annotated image; and
responsive to the detecting of the selection of the particular selectable virtual graphical object, providing, by the computing device, a plurality of selectable tabs associated with the particular selectable virtual graphical object, wherein each tab of the plurality of selectable tabs is linked to a media content associated with the particular portion.

22. The computer-implemented method of claim 21, further comprising:
detecting, by the computing device, a selection a selectable tab of the plurality of selectable tabs; and
responsive to the detecting of the selection of the selectable tab, providing, by the computing device, the linked media content associated with the selected selectable tab.

23. The computer-implemented method of claim 21, wherein the linked media content associated with the particular portion comprises one or more of a textual description, another image, a video content, a universal resource locator, or an audio content.

24. The computer-implemented method of claim 21, wherein the annotated images are provided by an enterprise platform.

25. The computer-implemented method of claim 24, wherein the enterprise platform is associated with a commercial product, wherein the displayed annotated image is an illustration of the commercial product, wherein the one or more selectable virtual graphical objects correspond to respective portions of the commercial product, and wherein the linked media content associated with the particular portion relates to a feature of the particular portion of the commercial product.

26. The computer-implemented method of claim 24, wherein the enterprise platform is configured to provide an instruction manual for a product, wherein the displayed annotated image is an illustration from the instruction manual for the product, and wherein the linked media content associated with the particular portion relates to one or more instructions related to the particular portion of the illustration.

27. The computer-implemented method of claim 24, wherein the enterprise platform is configured to provide a repair manual for a product, wherein the displayed annotated image is an illustration from the repair manual for the product, and wherein the linked media content associated with the particular portion relates to one or more repair instructions related to the particular portion of the illustration.

28. (canceled)

29. (canceled)

30. (canceled)

31. (canceled)

32. (canceled)
